(19) United States
(12) Patent Application Publication
(10) Pub. No.: US 2009/0106124 A1
(43) Pub. Date: Apr. 23, 2009

(54) METHOD AND APPARATUS FOR ORDERING AND DELIVERING OF MEALS

(76) Inventor: Ping YANG, Chino Hills, CA (US)

Correspondence Address: SHELDON MAK ROSE & ANDERSON PC, 100 Corson Street, Third Floor, PASADENA, CA, 91103-3842, US

(21) Appl. No.: 12/341,952

(22) Filed: Dec. 22, 2008

Related U.S. Application Data
(63) Continuation-in-part of application No. 11/682,829, filed on Mar. 6, 2007.
Application No. 11/682,829 is a continuation-in-part of application No. 10/798,965, filed on Mar. 10, 2004, now abandoned.
Application No. 10/798,965 is a continuation-in-part of application No. 10/681,685, filed on Oct. 8, 2003, now abandoned.
Application No. 10/681,685 is a continuation-in-part of application No. 10/055,144, filed on Jan. 22, 2002, now abandoned.
Application No. 10/055,144 is a continuation-in-part of application No. 09/733,873, filed on Dec. 8, 2000, now Pat. No. 7,110,958.
(60) Provisional application No. 60/263,530, filed on Jan. 22, 2001.
(60) Provisional application No. 60/301,761, filed on Jun. 28, 2001.
(60) Provisional application No. 60/453,053, filed on Mar. 8, 2003.
(60) Provisional application No. 60/453,664, filed on Mar. 11, 2003.
(60) Provisional application No. 60/458,156, filed on Mar. 27, 2003.
(60) Provisional application No. 60/465,314, filed on Apr. 25, 2003.
(60) Provisional application No. 60/472,310, filed on May 21, 2003.
(60) Provisional application No. 60/483,783, filed on Jun. 28, 2003.
(60) Provisional application No. 60/779,539, filed on Mar. 6, 2006.
(60) Provisional application No. 60/782,763, filed on Mar. 16, 2006.
(60) Provisional application No. 60/789,173, filed on Apr. 4, 2006.
(60) Provisional application No. 60/794,964, filed on Apr. 25, 2006.
(60) Provisional application No. 60/799,105, filed on May 10, 2006.
(60) Provisional application No. 60/808,811, filed on May 26, 2006.
(60) Provisional application No. 60/810,531, filed on Jun. 1, 2006.
(60) Provisional application No. 60/811,622, filed on Jun. 7, 2006.
(60) Provisional application No. 60/833,325, filed on Jul. 26, 2006.
(60) Provisional application No. 60/834,768, filed on Jul. 31, 2006.
(60) Provisional application No. 60/852,883, filed on Oct. 19, 2006.
(60) Provisional application No. 60/879,774, filed on Jan. 10, 2007.
(60) Provisional application No. 61/009,008, filed on Dec. 22, 2007.
(60) Provisional application No. 61/189,993, filed on Aug. 25, 2008.
(60) Provisional application No. 61/192,429, filed on Sep. 17, 2008.
(60) Provisional application No. 61/200,252, filed on Nov. 25, 2008.

(51) Int. Cl. G06Q 30/00

(52) U.S. Cl. 705/26

(57) ABSTRACT

A method and system for taking orders, scheduling delivery and delivering products to customers. In the method, available pickup locations are selected, and a customer's order to is delivered to a pickup location that is convenient for the customer. The entity operating the delivery process aggregates orders assigned to the same pickup location. A Mobile Pickup Station (MPS), carrying all the orders assigned to the pickup location, is dispatched to the pickup location and stays at the pickup location for a predetermined period of time waiting for customers to pick up their orders.

### CROSS-REFERENCE TO RELATED APPLICATIONS

This application is a continuation-in-part of U.S. patent application Ser. No. 11/682,829 filed Mar. 6, 2007, which is a continuation-in-part of U.S. patent application Ser. No. 10/798,965 filed Mar. 10, 2004 (now abandoned), which is a continuation-in-part of U.S. patent application Ser. No. 10/681,685 filed Oct. 8, 2003 (now abandoned), which is a continuation-in-part of U.S. patent application Ser. No. 10/055,144 filed Jan. 22, 2002 (now abandoned), which is a continuation-in-part of U.S. patent application Ser. No. 09/733,873 filed Dec. 8, 2000. The application Ser. No. 10/055,144 claims the benefit of U.S. Provisional Patent Application No. 60/263,530 filed on Jan. 22, 2001, and U.S. Provisional Patent Application 60/301,761 filed Jun. 28, 2001. The application Ser. No. 10/681,685 claims the benefit of U.S. Provisional Patent Application No. 60/453,053 filed Mar. 8, 2003, U.S. Provisional Application No. 60/453,664 filed Mar. 11, 2003, U.S. Provisional Application No. 60/458,156 filed Mar. 27, 2003, U.S. Provisional Application No. 60/465,314 filed Apr. 25, 2003, U.S. Provisional Application No. 60/472,310 filed May 21, 2003 and U.S. Provisional Application No. 60/483,783 filed Jun. 28, 2003. The application Ser. No. 11/682,829 claims the benefit of U.S. Provisional Patent Application No. 60/779,539 filed Mar. 6, 2006, U.S. Provisional Patent Application 60/782,763 filed Mar. 16, 2006, U.S. Provisional Patent Application No. 60/789,173 filed Apr. 4, 2006, U.S. Provisional Application No. 60/794,964 filed Apr. 25, 2006, U.S. Provisional Application No. 60/799,105 filed May 10, 2006, U.S. Provisional Application No. 60/808,811 filed May 26, 2006, U.S. Provisional Application No. 60/810,531 filed Jun. 1, 2006, U.S. Provisional Application No. 60/811,622 filed Jun. 7, 2006, U.S. Provisional Application No. 60/833,325 filed Jul. 26, 2006, U.S. Provisional Application No. 60/834,768 filed Jul. 31, 2006, U.S. Provisional Application No. 60/852,883 filed Oct. 19, 2006 and U.S. Provisional Application No. 60/879,774 filed Jan. 10, 2007. The present Application claims the benefit of U.S. Provisional Patent Application No. 61/009,008 filed Dec. 22, 2007, U.S. Provisional Patent Application 61/189,993 filed Aug. 25, 2008, U.S. Provisional Patent Application No. 61/192,429 filed Sep. 17, 2008, and U.S. Provisional Application No. 61/200,252 filed Nov. 25, 2008. The entire disclosure of each of the foregoing patent applications is incorporated by reference as if set forth in full herein. Any disclaimer that may have occurred during the prosecution of the above-referenced application(s) is hereby expressly rescinded.

### BACKGROUND OF THE INVENTION

For a variety of reasons, consumers buy ready-made meals from food service providers such as restaurants or grocery stores, and take them home to eat. For example, some are too tired to cook after a long day of work and to gather a whole family to eat in restaurants on a regular basis is difficult. Some consumers want to enjoy the relaxed nature of eating in their own homes. Others want to save money on tips by eating purchased food at home instead of in a restaurant. Therefore, buying food and eating at home becomes an alternative.

However, buying food to eat at home can be troublesome. For example, determining where to purchase the food to eat is frustrating enough and traveling to the restaurant to pick up the food can be time consuming. In addition, since members in a household may have different meal preferences, picking up different meals for family members from different restaurants on a daily basis is time consuming and exhausting. As a result, often one person gets what he/she wants, and the others might get their choice the next time.

There are delivery services that deliver restaurant foods to customers' homes, but these delivery services can be very costly and unavailable to many consumers. For example, a typical conventional delivery service, such as Restaurant-On-The-Run (www.rotr.com) or imposes a minimum order requirement of $15.00, charges a $5.99 delivery fee and expects a tip of about 15% paid to its driver. Over time, frequent use of this service becomes expensive, making it impossible for most households to use it regularly. Furthermore, the minimum order requirement limits the service's customer base. For example, a single person who only wants to order a meal for himself/herself (typically under $10.00) will find no such delivery service available to fit his/her needs.

The traditional model of obtaining take-out food is inconvenient, costly, and frustrating. There is a need for a meal delivery service that offers convenience, better quality, and savings. The present invention satisfies such a need.

### SUMMARY OF THE INVENTION

It is an object of the present invention to provide a delivery system that is convenient for a customer to receive products ordered by the buyer.

It is another object of the present invention to provide an efficient delivery method by avoiding costs associated with door-to-door delivery.

It is another object of the present invention to deliver products to a customer face-to-face thus eliminating the risk of leaving products at a customer's address and leaving the products attended when the customer is not at the address to receive the products.

In one embodiment of the invention, a large number of customers' meal orders are delivered to a pickup location waiting to be picked up. The delivery cost per order is low. The operator of the delivery service can deliver the orders with “no tips, no delivery fees and no minimum orders”.

In one embodiment of the invention, a pickup location's hours of operation is determined by the projected customer arrival distribution at the pickup location, combined with a cost and benefit analysis at that location.

In one embodiment of the invention, an improved method of displaying pickup locations to a buyer is presented.

### BRIEF DESCRIPTION OF THE DRAWINGS

FIG. 1 and FIG. 2 are flowcharts showing the process from user's commuting route selection to user pickup at a mobile pickup station;

FIG. 3 is a flowchart showing an exemplary process to select available pickup points;

FIG. 4 is a flowchart showing third-party buying coupled with a mobile pickup station delivery service;

FIG. 5 shows selection of mobile pickup point with two users;

FIG. 6 shows selection of mobile pickup point with a new user joining in;

FIG. 7 shows the searching method by using the user's commuting route and a channel;

FIG. 8 shows the user's input of the occurrence rate for a desired product;

FIG. 9 is a diagram presentation of multiple territories with covered routes in accordance with an exemplary embodiment of the present invention;

FIG. 10 shows the overlapping of user channels and a server's selection of available pickup points.

FIG. 11 shows a first model of the arrangement of shipping third party products to a mobile pickup station warehouse.

FIG. 12 shows a second model of the arrangement of shipping third party products to a mobile pickup station warehouse;

FIG. 13 shows a third model of the arrangement of shipping third party products to a mobile pickup station warehouse;

FIG. 14 is a diagram showing pickup point selection.

FIG. 15 is a flowchart presentation of the searching method by using user commuting route and a channel;

FIG. 16 is a network diagram depicting an embodiment of an MPS using the Internet as a communication medium;

FIG. 17 is a diagram of computer architecture of a computer capable of hosting a mobile pickup station server;

FIG. 18 is a diagram showing an example of Customer Pass-by Distribution or Customer Arrival Distribution.

FIG. 19A, FIG. 19B and FIG. 19C are diagrams showing an example of how to determine which area in a map to display to a buyer.

### DESCRIPTION OF THE PREFERRED EMBODIMENT(S)

The detailed description set forth below in connection with the appended drawings is intended as a description of presently preferred embodiments of the invention and is not intended to represent the only forms in which the present invention may be constructed and/or utilized. The description sets forth the functions and the sequence of steps for constructing and operating the invention in connection with the illustrated embodiments. However, it is to be understood that the same or equivalent functions and sequences may be accomplished by different embodiments that are also intended to be encompassed within the spirit and scope of the invention.

As used herein, the term “comprise” and variations of the term, such as “comprising” and “comprises,” are not intended to exclude other additives, components, integers or steps. The terms “a,” “an,” and “the” and similar referents used herein are to be construed to cover both the singular and the plural unless their usage in context indicates otherwise.

### DESCRIPTION

Referring to the drawings where like numerals of reference designate like elements throughout, it will be noted that the present invention is referred to herein as a Mobile Pickup Station (MPS) delivery system. A MPS delivery system uses pickup stations in the form of vehicles, lockers or moveable kiosks used in conjunction with the Internet to provide maximum convenience for a buyer to pick up products. A mobile pickup station may be stationed along a buyer's travel route so that the buyer can conveniently pick up products at the station when traveling without spending extra time traveling to a seller's store to pick up the products.

Most people commute to work via the same commuting route every day. Others, while not working, travel to the same place repeatedly. Even the time people start and end their commuting and the time spent on commuting is about the same day after day. In one embodiment, the mobile pickup station system arranges to ship products a buyer ordered to a location that is close to the buyer's daily commuting route. Under such an arrangement, a buyer can pick up the products while conducting the buyer's daily commuting commute without spending extra time traveling to a seller's store to pick up the products. This is a more convenient way for the customer to receive products. This pickup location will be referred to as the mobile pickup point (or mobile pickup location).

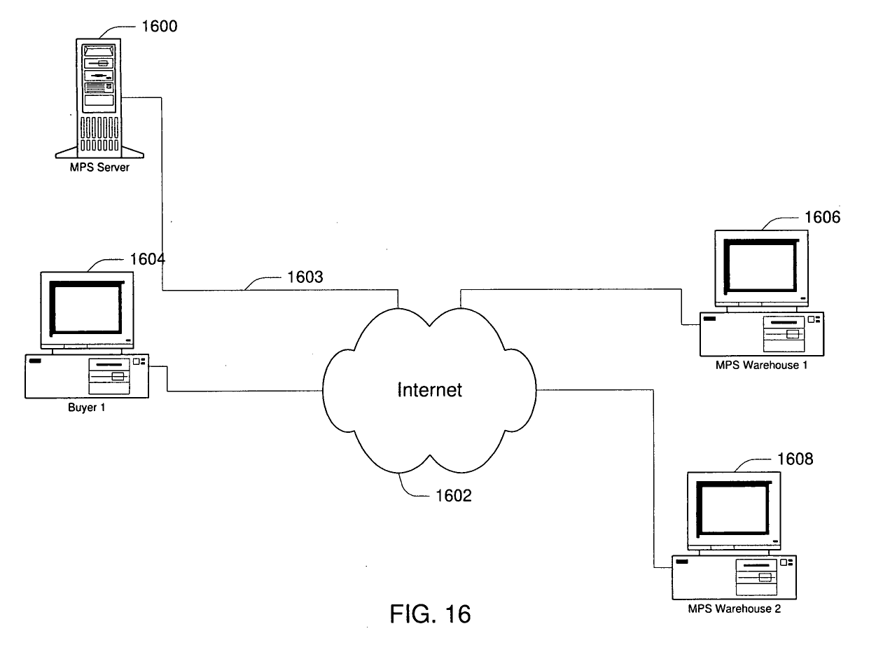

FIG. 16 is a network diagram showing an embodiment of an MPS server using the Internet. A MPS server 1600 is operatively coupled to the Internet 1602 via a communications link 1603 adapted for communications using the Transmission Control Protocol/Internet Protocol (TCP/IP) suite of networking protocols such as Hyper Text Transfer Protocol (HTTP) for hypertext document transfer and Simple Mail Transfer Protocol (SMTP) for the transfer of electronic (email) messages.

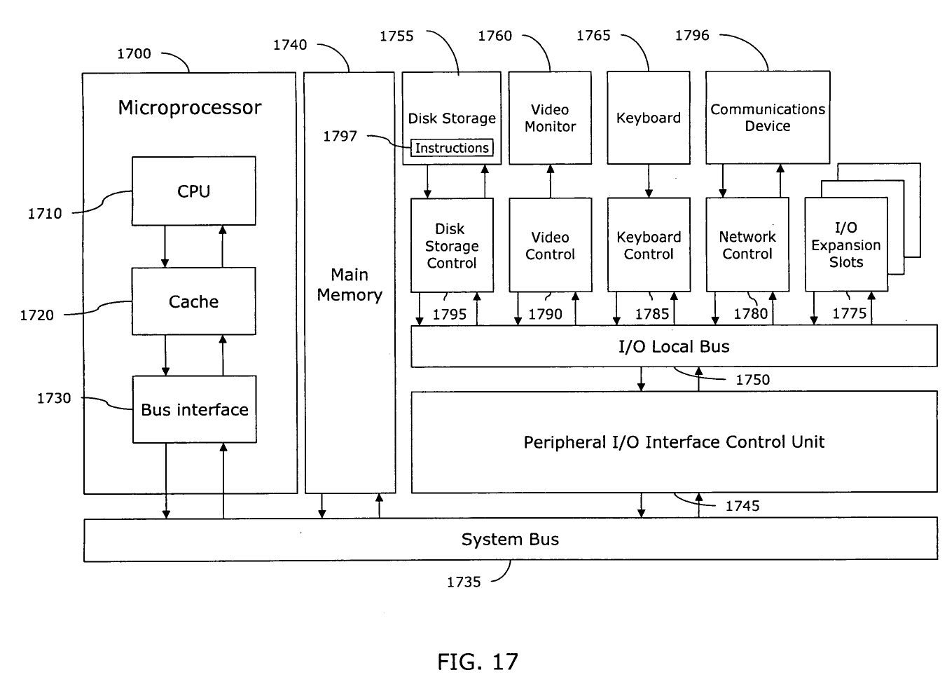

FIG. 17 is a hardware architecture diagram of a computer suitable for use as a MPS server host. Microprocessor 1700, comprised of a Central Processing Unit (CPU) 1710, memory cache 1720, and bus interface 1730, is operatively coupled via system bus 1735 to main memory 1740 and I/O control unit 1745. The I/O interface control unit is operatively coupled via I/O local bus 1750 to disk storage controller 1795, video controller 1790, keyboard controller 1785, and communications device 1780. The communications device is adapted to allow software objects hosted by the computer to communicate via a network with other software objects. The disk storage controller is operatively coupled to disk storage device 1755. The video controller is operatively coupled to video monitor 1760. The keyboard controller is operatively coupled to keyboard 1765. The network controller is operatively coupled to communications device 1796. The communications device provides a communications link adapted for communications over the Internet.

Computer program instructions 1797 implementing a MPS server are stored on the disk storage device until the microprocessor retrieves the computer program instructions and stores them in the main memory. The microprocessor then executes the computer program instructions stored in the main memory to implement a MPS server.

Referring again to FIG. 16, a buyer uses a computer 1604 running an Internet browser to access the MPS server via the Internet. The buyer's computer is operatively coupled to the Internet via a communications link adapted for communications using TCP/IP based networking protocols such as HTTP for hypertext document transfer. The MPS server provides scheduling services for at least one regionally distributed MPS warehouse. Each MPS warehouse communicates with the MPS via the Internet using computers as exemplified by MPS warehouse computers 1606 and 1608. Each MPS warehouse computer is operatively coupled to the Internet via a communications link adapted for communications using TCP/IP based networking protocols such as HTTP for hypertext document transfer and SMTP for the transfer of email messages.

In operation, a buyer may access the MPS server via the Internet and may use the delivery scheduling services of the MPS server to define a pickup point for use by the buyer. The MPS server may determine which MPS warehouse is used to dispatch a MPS to the defined pick up point with the buyer's products.

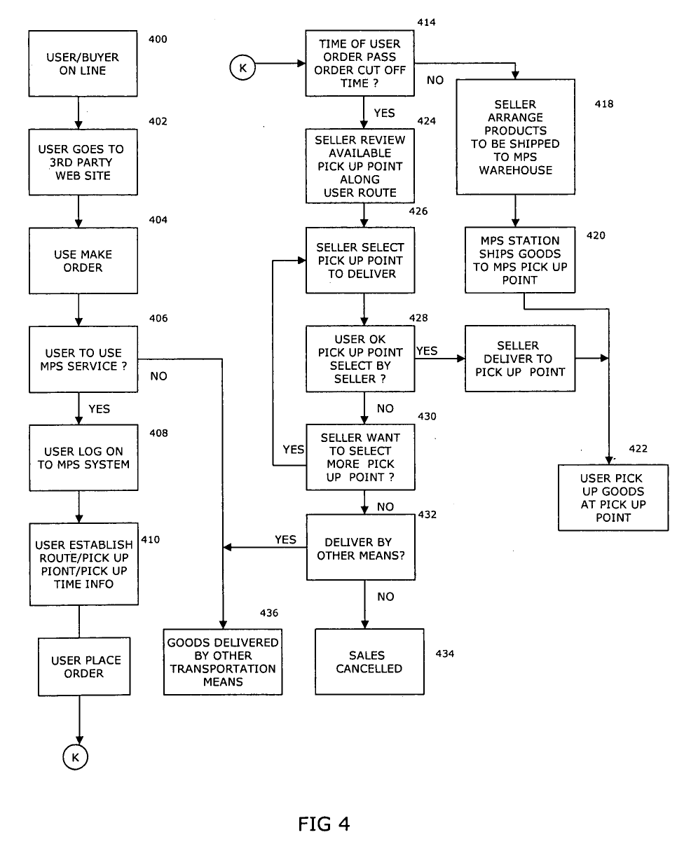

Referring now to FIG. 5, user A and user B use the Internet for shopping and ordering products at the server's website. User A and user B may identify their daily preferred commute route as route AA 10 and route BB 12, respectively. A MPS system may store this route information in its memory. The MPS system may identify route segment FG as a commuting route segment that is commonly used by user A and user B. A MPS system may achieve maximum convenience for both user A and user B by sending a MPS station, which carries products ordered by user A and user B and stations at a place (e.g. point J 18) along a route segment (e.g. segment FG) that is common to the commuting routes of user A and user B and waits for user A and user B to pick up their ordered products.

Every point in a route can be represented by a location parameter. The value of the location parameter defines a point (i.e., a location) on the route. An example of such a parameter is the street address of the point or the longitude and latitude coordinates of the point. For example, point F 14 can be represented by its street address or its longitude and latitude coordinates. A pickup point can be considered along a route when it is at the side of that route. A point that is on or contained in a route is definitely considered as along the route. For example, M 19 can be considered “along” segment FG because point M19 is contained in segment FG. Thus, a pickup point can be considered “along” a route when the parameter value of the pickup point equals the parameter value of a point contained in the route.

One method a server can use to determine if a point, e.g. X, is along a user's commute route, e.g. Y, is as the following: the server can determine the parameter value of point X. The server can then determine the parameter values of all the points on route Y. The server then compares the parameter value of X to the parameter values of all the points on route Y. If the parameter value of X equals the parameter value to one of one of the points on route Y, point X can be determined as along route Y.

The server can use an alternate method to determine if a point is along a user's commute. The method is as follows: Assuming all the parameter values of the points in FIG. 5 are street addresses. R 23 and S 24 are two points on route AA 10. The street address of R 23 is 1250 San Gabriel Blvd, Rosemead, Calif. The street address of S 24 is 3230 San Gabriel Blvd, Rosemead, Calif. And the street address of M 19 is 2240 San Gabriel Blvd, Rosemead, Calif. M 19 can be determined to be along route AA 10, because it is between R 23 and S 24 and both R and S are on route AA. Here, 3230≧2240≧1250. In the method, a point is considered to be along a route if it is between two points. The two points are all on the route.

The same concept can be extended to a situation where a point is represented by its longitude and latitude values. Assuming in FIG. 5, Point R 23's longitude and latitude coordinates are (X1, Y1). Point M 19's longitude and latitude coordinates are (X2, Y2). And Point S 24's longitude and latitude coordinates are (X3, Y3). Again, R 23 and S 24 are on route AA 10. The server can determine that M is along route AA if X2 is in between X1 and X3, and Y2 is in between Y1 and Y2. That is X1≧X2≧X3 or X3≧X2≧X1. Y1≧Y2≧Y3 or Y3≧Y2≧Y1.

In the present invention, a point that is a distance away from the route can still be regarded as along a route, if the server can draw a vertical line from the point to the route and the intersection of the vertical line and the route falls within the route. For example, in FIG. 5, line VV 15 is a straight line drawn from point J 18 to Route FG 14. T 25 is the intersection of straight line VV 15 and FG 14. At Point T 25, VV 15 is vertical to FG 14. J 18 can be regarded as along FG 14 if T 25 is between Point F and Point G.

A pickup point that is too far away from a buyer's travel route would be useless and impractical, because the buyer may not want to use that pickup point. To be practical, the server can further limit the meaning of “along a route” by the distance between a point and the route. In this situation, a pickup location is considered “along a route” if it is within a reasonable distance, e.g. 10 miles, from the route. So in FIG. 5, Point J 18 would be regarded as along Route FG if it is located on a street that is no more than 10 miles away from Route FG.

A pickup point may be on the intersection of two crossing streets and have an official street address of one of the streets at the intersection. For example, point M 19 may be on the intersection of San Gabriel Blvd and Garvey Ave but have an official street address of 125 Garvey Ave. In this case, the server can arbitrarily assign point M with a nearby San Gabriel Blvd address in order to located pickup points on either San Gabriel Blvd or Garvey Ave.

By knowing the parameter values of two points, the server can calculate the distance between the two points.

The distance between a pickup point and a route can be defined by many ways. For example, it can be defined by the vertical distance between the pickup point and the route. Using FIG. 5 as an example, the distance between J 18 and route AA 10 is distance between T 25 and J18. Or, the server can find the straight line distances between the pickup point and the exist points on the route. The server can define the distance between the pickup point and the route as the shortest straight line distance between the pickup point and the exist points on the route. Or, the server can find the road-traveling distances between the pickup point and the exist points on the route. The server can define the distance between the pickup point and the route as the shortest road-traveling distance between the pickup point and the exist points on the route. An exit point on a route (termed “route exit”) is an exit that a user can use to get off the route and travel to a pickup point. For example: assuming the user's travel route is Highway 10. The San Gabriel Blvd exit on Highway 10 is a “route exit” because a buyer can use it to get off the highway and travel to a pickup point. If the rout is a major street, a route exit can be an intersection on the major street with another street a buyer can use to travel to a pickup point. A road-traveling distance between two points is defined as the driving distance on a route connecting the two points.

A route segment that is common to the commuting routes of two users is the same as an overlapped segment of the two commuting routes. An overlapped segment, e.g. FG, which more than one customer uses, can be found by using the following method: a computer program is stored in the computer. The program collects the parameter values of all the points in all customers' routes. The program then compares all the parameter values and identifies the points where multiple customers' routes contain points with the same parameter values. The program then collects the points with the same parameter values. A collection of the points with the same parameter values in two buyer-routes forms a route segment that is commonly used by the two buyers. The program can calculate and determine the distance of two points once the parameter values of the two points are identified.

Once a pickup point that is determined to be along a buyer's commute route, the pickup point can be selected for the buyer to use. The buyer's order can be delivered to the pickup point. The buyer can come to the pickup point to pick up the order.

A MPS is a vehicle, a locker or a moveable kiosk that has the capacity to carry different types of products. For instance, in addition to the ability to carry general nonperishable products, a MPS may be equipped with an electricity generator that may power a refrigerator and/or heater to preserve perishable food products (i.e. food that may or is likely to decay or spoil if not transported under appropriate conditions and/or within a predetermined period of time) it carries within a temperature range that meets government requirements. In one MPS in accordance with an embodiment of the present invention, the MPS is connected to a power source, such as a solar power panel or a conventional electrical connection, to receive power to cool or heat the products it carries. In another MPS, in accordance with an embodiment of the present invention, one or more operators or attendants stay with the MPS station to operate it; for example to pass products to a buyer/user when the buyer/user comes to the station to pick up product ordered, to receive products from the user when he comes to the station to drop off products, or to prepare products to its ready condition and give it to user, etc.

In another embodiment of the present invention, a MPS may be equipped with a computer, a wireless transmitter and/or receiver so that it can communicate with a MPS server, get access to the Internet, get access to a MPS Intranet, or communicate with users or other parties.

In another MPS, in accordance with an embodiment of the present invention, the moveable kiosk has a plurality of lockers and the buyer or user is given an ID code and/or a password to open the locker to take the products he ordered. In this case, it would not be necessary to have an operator or attendant at the side of the kiosk to serve the buyer/user.

A pickup point can be anywhere as long as it can accommodate the parking of a mobile pickup station. An exemplary MPS mobile pickup point (e.g. point J) is a place that is close to the overlapped user route (e.g. route segment FG), is easy to get access to from the user route and is convenient for the user to park or to walk to. It may be the parking lot of a shopping mall, a gas station or a wide street with the capacity to park a MPS.

A mobile pickup point may also be a place where the MPS system can station a moveable kiosk, such as a subway station or at a street crossing, etc. A MPS station can be stationed at a pickup point for a pre-determined period of time (the “Station Time”) waiting for users to pick up their orders. The pre-determined station time is announced to users in advance. If the MPS station is a vehicle, an operator drives the station to the designated pickup point and stays there. If the MPS station is a moveable kiosk, a truck may drop the kiosk off at the designated pick up point and pick it up, and return the MPS to a MPS warehouse when the station's station time is up for reloading.

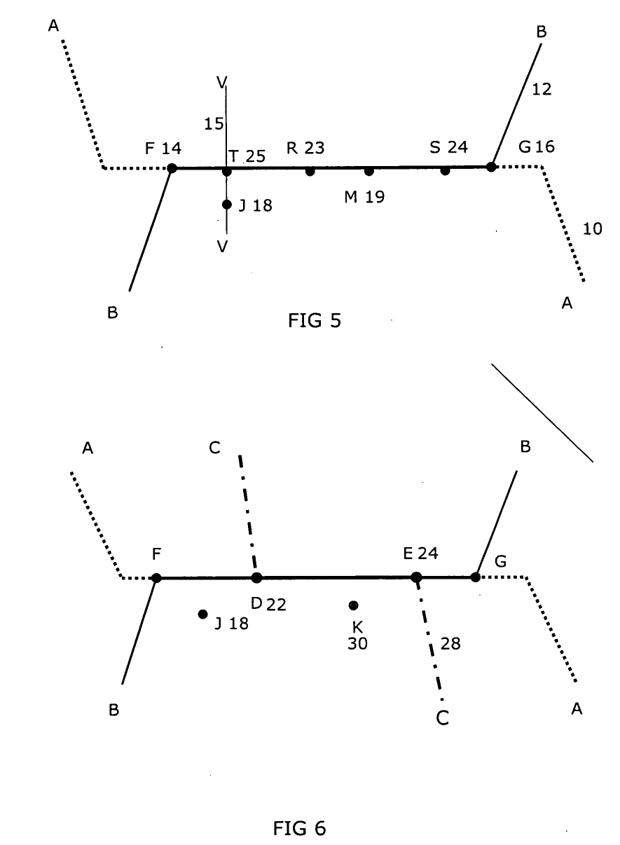

Referring to FIG. 6, assume user C joins a MPS system serving user A and user B. Further assume user C uses commuting route segment CC 28. Because pickup point J 18 is not within user C's commute route CC, the MPS system, must select a different pick up point to accommodate A, B, and C simultaneously to achieve maximum convenience to all. Point K 30, which is along route segment DE 22 and is common to all route segments AA, BB, and CC, can thus be selected as a pick up point to serve users A, B, and C. If more than one pickup point is located along an overlapped route section (e.g. DE), the server can find the pickup point that is the closest to the overlapped route section. The server can select or release the pickup point for buyers to use to achieve maximum convenience.

A server can find the pickup point that is the closest to a travel route, which is the pickup point with the shortest distance from the travel route.

The server can use the same method to find the pickup point that is the closest to an overlapped route section.

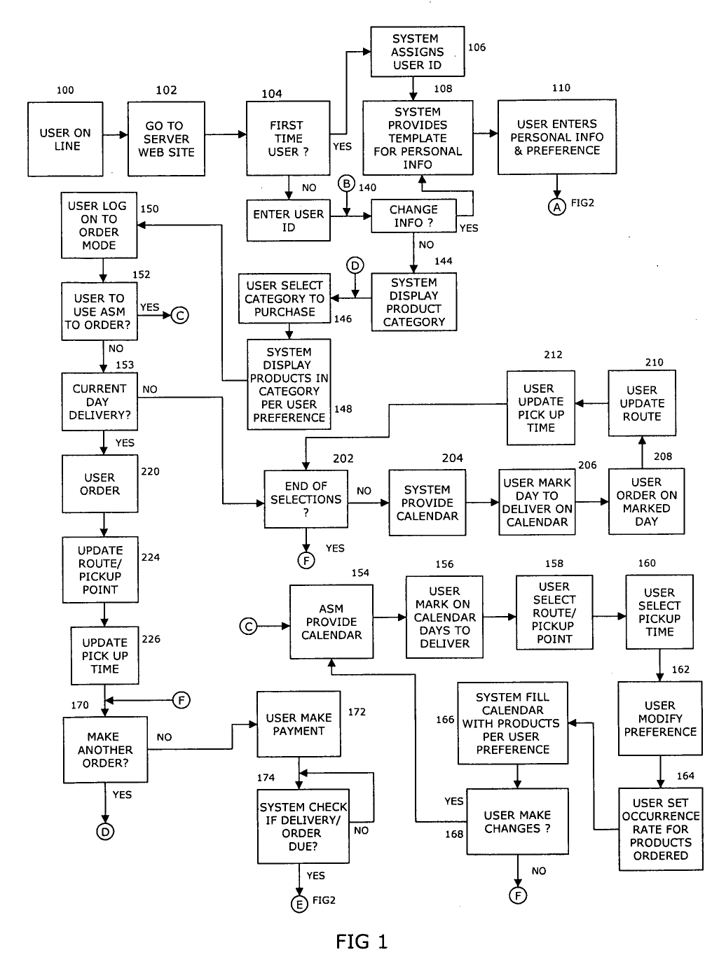

Referring to FIG. 1, a user/buyer uses at step 100 the Internet to access a Website using a Personal Computer (PC), a laptop, a Palm Pilot, a web-accessing cellular phone, or any other means of Internet access. The user/buyer is the person who purchases a product and/or MPS service from the Website. In the case where the Website is maintained by a transportation business entity providing MPS delivery services without selling any physical products, the buyer is the one who uses MPS services to have their products delivered.

The buyer goes to the Website hosted by a MPS server at step 102. An MPS server is a server maintained by a business entity that operates a MPS system. The business entity, which may be a retail or wholesale business entity with a fleet of MPS stations, sells products to a buyer. It may be a transportation business entity, which operates a fleet of MPSs, and delivers products for its customers or it may be another type of business entities that operate a fleet of MPSs. For easy referencing, the word “server” herein may also mean the business entity that operates a MPS system.

The server may ask if the buyer is a first time buyer at step 104. If the buyer is not a first time user, the buyer may enter user ID and/or password to log-on to the server website and goes to step 140. If the buyer is a first time buyer, the system may assign the buyer an ID and a password for his/her use at step 106. The server provides a template for the buyer to enter his/her personal information at step 108.

The buyer may enter personal information such as name, home or office addresses, phone number, age, credit card number, etc. at step 110. At this stage, the server may ask the buyer to enter the buyer's preference of purchases. As herein used, purchase means purchase of products and/or services. This preference is a tool the server may use later to screen products and display preferred products to the buyer. For example, if the server is maintained by a food manufacturing company, e.g., a food catering business, the preference questions listed may be: Does the buyer like spicy food? Should the food be slightly spicy, medium spicy, or very spicy? Does the buyer care for red meat in the food? The maximum calorie and fat count in the food? What is the preference of ethnic foods? Italian food, Japanese food or other food? Also, the preference questions may contain specific dollar limitations the buyer wants to spend on meals (or orders). The dollar limitations may be the maximum dollar amount the buyer wants to spend on a meal or maybe the budget of spending for a specific period of time such as a week, a month, etc. The preference information may be input by the buyer using a template provided by the server. Alternatively, the server may use the customer's personal information such as the customer's last name (an indication of ethnic group the customer belongs to), gender, address (to determine the area the customer is living in), or other information to create a projected set of preferences that may match the customer's. Another way of obtaining the customer's preferences that the server may use is to collect the customer's order history and analyze this information to project the buyer's purchasing preferences.

Referring to FIG. 2, the buyer then goes to a route selecting mode at step 112 to choose a commuting route. In this mode, a template is presented to the buyer to enter the beginning and the end addresses of the buyer's commuting route at step 114. In another embodiment of a MPS in accordance with the present invention, in defining beginning and end route information, the buyer/user is allowed to enter the zip codes or the telephone numbers at the beginning and end of the route. The system can then identify the general area of the beginning and the ending of the route and display a map that covers the general area of the beginning and end of the route with all possible routes available to the user. Well-known landmarks, city names, county names or the cross streets with city information at each end of the user route may be used to identify the general area of the route in a similar fashion. When the system allows the user to enter their telephone number at each end of the user route, the system may use the area codes and the prefixes of the telephone numbers to identify the general area of the beginning and end of buyer/user's commute route and may display the map. When the map that covers the general area is displayed, the server may display all available pick up points covered by the map for the user's selections. In the present invention, landmark means the description of a well-known location, it may be a shopping mall, city hall or even highway exits, etc.

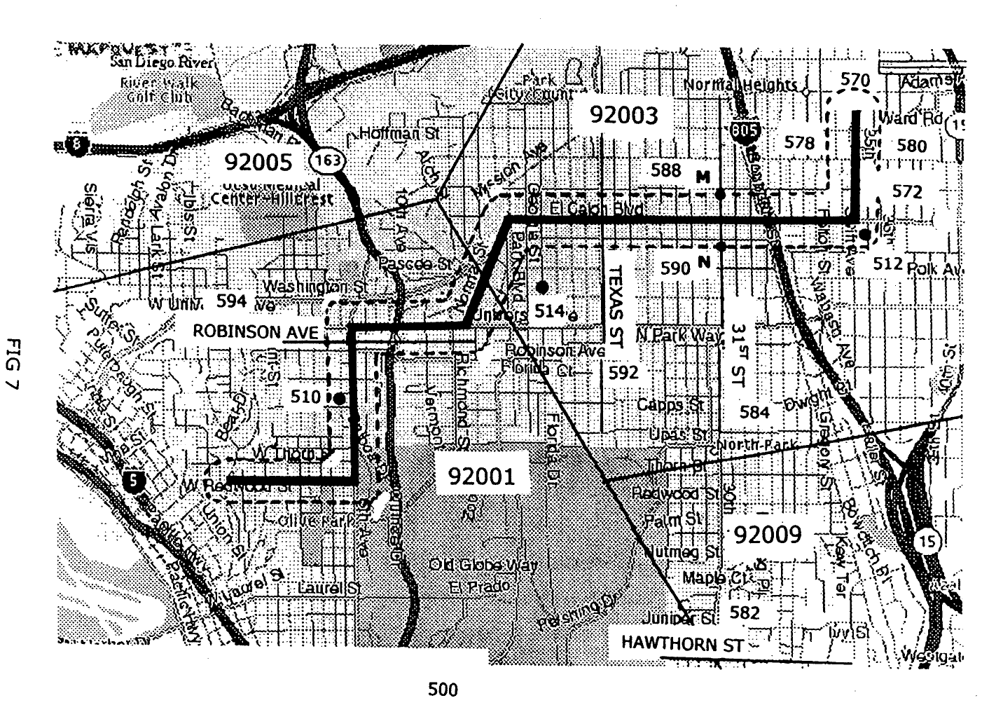

Referring to FIG. 7, in one embodiment of a MPS server, a MPS server displays a map 500 that covers the beginning and the ending address of the buyer's commute route. The map may display all streets and freeways between those two ends. The buyer may click or depress and drag the mouse across the map to define a chosen route 570. In another embodiment of the present invention, a buyer is prompted to enter a distance from the buyer's chosen route that the buyer is willing to travel to pick up a product. The distance from the buyer's chosen route that the buyer is willing to travel is herein termed a channel width. The channel width is used by the MPS server to define channel boundaries 578 and 580 around the chosen route. This channel width combined with the buyer's chosen route creates a channel 572. As described herein, the server may present available pick up points along the user route for the user's selection. When available pick up points are presented along the user route, the server may display the channel to the user for the following purposes: the user/buyer may know the distance or location each available pick up point relative to the user route (i.e., the buyer may use this channel as a distance reference) or the buyer may indicate to a MPS server that this channel width is the distance the buyer is willing to travel away from the buyer's commute route. In the latter case, the server may only display those available pick up points that fall within user channel.

In another embodiment, there are two methods to determine the distance-defined channel width, 1) the straight-line distance method and 2) the road-traveling distance method. To define straight-line distance channel boundaries, the server may select a point on a user-chosen route. The point selected may be any point on the user-chosen route. The server then uses the point as center and uses the selected channel width as a radius to form a circle. The points on the circle that are the furthest away from the user route are straight-line channel boundaries. A channel is then a collection of channel boundaries.

A preferred road-traveling distance is the distance a user is willing to travel on the road away from the user-selected commute route. For example, a preferred road-traveling distance of two miles means the user is willing to drive two miles away from his selected commute route to pick up an order.

The system may allow the user to select either a straight-line distance method or a road-traveling distance method or both to build a channel.

In another embodiment to define a route, the server may allow the buyer to click on the map (or to enter the names) of some or all the streets or highways the buyer prefers to travel. The MPS server may then connect those streets or highways together with the shortest distance and further connect the buyer's beginning and ending addresses to build a chosen route.

The buyer may use the following procedures to click and build his/her chosen route on a map 500. The buyer starts with his/her beginning address, e.g., his/her home address, at this time the MPS server registers a reference point, which is the buyer's home address on the buyer's home street. The buyer then clicks on the map a second street the buyer will travel. The intersection of the second street and the buyer's home street become a second reference point.

The system may register the route between the first and the second reference points as a portion of the buyer's chosen route. The buyer may then click a third street the buyer will travel. The intersection of the second and the third street becomes a third reference point. The MPS server then registers the route between the second and the third reference points as a portion of the buyer's chosen route. The buyer keeps on going with the process until the buyer reaches the buyer's end address, which would be the buyer's final reference point. The MPS server registers a final route portion and the whole route may thus be identified as the buyer's chosen route.

Alternatively, the buyer may start a route selecting process by clicking on the map on one of the streets within the buyer's commuting route and then clicking on the map the streets the buyer travels on before and after that street. The system then uses the intersections of these streets to establish reference points for the MPS server to construct the buyer's route. In the case where the buyer forgets or neglects to click to identify any of the traveled street(s) within his/her route, the system searches street(s) that represent the shortest traveling distance between the clicked streets and connects those clicked streets. The same method can be used to connect the clicked streets to the buyer's beginning and/or end points of route. For example, if the buyer clicks the second and the fourth traveling streets, creating a set of sub-routes and forgets to click the third traveling street in the route, the system then generates a route by connecting the second and the fourth street with street(s) with a sub-route that represents the shortest distance between the two sub-routes to complete a whole route.

In another embodiment of the present invention, a user enters telephone numbers, zip codes, city names, county names or landmarks to identify the beginning and end of a route, and then the system displays a map that covers the general area of the route. The system may also display all available pick up points covered by the general area for the user's selection. An available pick up point may be displayed on a map. The map may be displayed to the user. An available pickup point may be displayed through a list or a drop down menu. However, if the user wants to establish a route within the general area, the user may then enter his/her beginning and the ending travel address or use his/her mouse to point the cursor at the places he wishes to travel, and click on it. The system may then register those addresses or clicked points as reference points to establish the route. This method can be used to establish the beginning and end of a user route.

Because a zip code, a telephone number, or a city name identifies an area instead of a point, the server system may use the center of the area or a well-known landmark in the area, to establish a reference point, if a reference point in the area is needed (for example: to establish a route, etc).

In another embodiment, the system may present to a buyer with a default route. The default route is the shortest route that connects the buyer's beginning traveling address and end traveling address. Major highways and/or major streets may be incorporated into the default route.

In another embodiment of the present invention, there is another option of building a default route. In this embodiment, the MPS server may display a route to the user that takes the least expected time to travel through.

In another embodiment of the present invention, the server may allow the user to select a channel width that is defined by the length of time a user is willing to spend traveling out of his/her commuting route to pick up an order. In this embodiment, the user is allowed to select a preferred traveling time he/she is willing to travel out of his/her commuting route to pick up his/her order. The server may then display a channel to the user that is defined by the user-selected preferred traveling time. The process of determining such a time-defined channel may be disclosed as follows:

The server may be able to determine or estimate the expected traveling time and the expected traveling speed a user travels through each block or section of a street in an area. By using this technique, the server may allow the user to select a preferred traveling time and use this preferred traveling time to build a time-defined channel. In one of the embodiments of the time-defined channel, the channel width, which is the driving distance from an exit of user commute route to channel boundary, is determined by how far, on average, a user may travel away from an exit of the user traveling route within the user-selected preferred traveling time.

When the selected location identifier is a zip code, telephone number or city name, it can define an area by itself. If the selected identifier is an address, which represents a point, a channel width may be selected either by user selection or by default to define an area. If the selected channel width is a straight-line distance, the defined area is a circle around the location identifier (e.g., an address) with the identifier as center and the distance as radius. If the identifier is an address and the channel width is defined by road-traveling distance or by preferred traveling time, the shape of the defined area may be irregular. The area is then defined by connecting boundaries that are defined by the selected road-driving distance or the preferred traveling time.

In another embodiment of the present invention, the buyer is allowed to change any portion of the default route built by the methods disclosed in the present invention as he/she wishes. A template may be provided to the buyer to type the names of which highways or streets the buyer is willing to travel out of the default route to pick up an order. Alternatively, the user may click the map on the places, the highways, or the streets on which the user is willing to travel out of the default route. The system then may connect these selected places, highways or streets to the default route with routes with the shortest distance or the shortest traveling time. A drop-down menu that contains defaulted streets and/or highways may be used to allow the buyer to click on and select his/her desired traveling route.

After the user selects his/her desired travel route, the system may display the expected travel time to travel to the user through the user-selected route by using the method described before.

Referring again to FIG. 7, assuming the buyer chooses a straight-line channel width, e.g., ¼ mile, and indicates that the channel width is the distance he/she wants to travel away from the route. The MPS server may display two channel boundaries 578 and 580 that wrap around and extend along the chosen route 570 with the distance from a boundary to the chosen route equal to ¼ mile. The area between the channel boundaries defines a channel around the chosen route. The MPS server may display all available pickup points 510 and 512 covered by the channel.

As shown in FIG. 7, a pickup point, such as 510 or 512, can be a location along the route of a buyer's commute and not the buyer's beginning or ending travel points. A typical pickup point is a location between the buyer's home and office, not at the buyer's home or office.

If there are no pick up points within the channel, the MPS server may then display those pickup points around the channel such as point 514. The MPS server at this time may decide if the MPS server wants to relocate a pickup point to a place within the channel, or the MPS server will wait until condition permits, e.g., more buyers use the same route, to establish an extra pick up point to serve the buyer. If the MPS server determines that no new pickup point should be established, the buyer may select a pickup point (e.g., 514) outside of the buyer's channel.

Referring again to the process flow diagram of FIG. 2, once the beginning and the end address of the route is defined, the MPS server may display a map with all the possible routes involved at step 116. The buyer may then click or depress and drag the mouse key on the map described in FIG. 7 to define the buyer's chosen route at step 118. The buyer can choose to set the chosen route as a default route at steps 120 and 122. If the chosen route is a temporary route because the buyer is temporarily traveling along a new commute route, the buyer may not want to set the chosen route as a default route. The buyer may select a width for the MPS server to develop a channel around a chosen route at step 123. The MPS server may then display a channel that wraps around and extends along the route at step 124 with the defined width. The MPS server may display the channel as previously described in FIG. 7. The system may display all available pick up points at step 126. The buyer may use the buyer/user's mouse to click a pick up point at step 128 to select the user's preferred pick up point. The system may then record the selected pick up point and its address. The server may then register the address of the selected pick up point as the delivery address of the user/buyer order. The server may not be the seller of the order, if this is the case, the address of the selected pickup point may be transmitted to the seller of the order. The delivery address, which is the address of the selected pickup point, is then included in the shipping label that is to be attached to the user order by the seller later. The delivery address may be a code that is established by the MPS entity to represent the pick up point. The buyer can set the pick up point to be the buyer's default pickup point if the buyer desires—refer to steps 130 and 132. The buyer may also enter the buyer's preferred pickup time at step 134. The buyer may also set this pick up time as default at steps 136 and 138. The server may set a station time as the time a MPS stays at the pickup point. The station time may be announced to the buyer at the time the buyer logs on to the server web site. The buyer may use it to plan the time to come to the pick up point to pick up his/her order. The buyer may come anytime within the station time to pick up the order. For example, the MPS server may set station time between 4 p.m. to 7 p.m. or 6 a.m. to 9 a.m. and the buyer comes between those times to pick up the buyer's products. A MPS may stay at the pick up point until all buyers pick up their products.

The pick up time entry, in the case no station time is set, gives the MPS server a planning tool as to how long a MPS will stay at a pickup point before the MPS is sent to a next assignment.

In one embodiment of a MPS server, the pickup time entry may be also used as a guide to send a reminder to the buyer for pickups. For example, if a buyer enters 7:30 a.m. as the buyer's pick up time, the MPS server may send a reminder at 7:00 a.m. to the buyer to remind the buyer that he has an order to pick up. The reminder may be very important if the order is to be picked up early in the morning. The reminder may be in the form of telephone calls to the buyer's office, home, or cellular phone. It may also be in the form of e-mails or messages sent to a buyer's Palm Pilot, or it may be by other means permitted by technology.

The preferred pickup time entry may be used by the MPS operator as a guide for the timing of the preparation of the user order as will be discussed later.

When a user enters his/her beginning and end travel route identifiers, if the user enters only one identifier and leaves the other identifier un-entered, the system may treat the un-entered identifier the same as the one entered. The beginning and end route identifiers may be entered as the same. In this case, the defined user commute route is a point.

The system may allow a user to use one or more location identifier for pickup location selection.

The system may allow a user to enter only one location identifier. If the identifier entered is an address, which defines a point, a channel width can be used to define an area to display pick up points. If the identifier entered is a city, telephone number, zip code, famous landmark, etc. that can define an area by itself, available pickup points may be displayed within the defined area for selection. In short, the MPS server may display a map with available pick up points for selection.

The MPS server may display many routes and many pickup locations on a map. A route is a pathway that connects two points and is available for traveling between the two points. A route can be a road, street, or highway. A route can be a combination of road(s), street(s), or highway(s). A buyer can use the routes displayed to him/her to identify the buyer's preferred travel route. Once the buyer's preferred travel route is identified, the buyer can determine the distance between a pickup location to the preferred route. The distance can be defined by straight-line distance, road-traveling distance, or time-defined distance as discussed before. The buyer can determine the pickup location that is the closest to the buyer's preferred route. The buyer can select the pickup location by clicking on it. Once the pickup location is selected, the MPS entity can make a record of the pickup location and can arrange to deliver the buyer's order to the pickup location for pickup. Preferably, the map is displayed to scale so that a buyer can readily compare the distance between each pickup location and the buyer's preferred route. In case the routes displayed in the map are not detailed enough and a buyer's actual preferred commuting route is not displayed in the map, the buyer can use the displayed routes to approximate his/her preferred route and use this information to select a pickup location to use.

A MPS server may let a buyer to select an identifier such as a route, channel, or location identifier (e.g. zip code, telephone, etc) and use the identifier to display a map and/or pickup locations to the buyer. A MPS server may set a server default identifier and use the identifier to display a map and/or pickup locations to the buyer. A server default identifier can be a route, channel, or location identifier (e.g. zip code, telephone, etc).

One method a server can use to determine if a point, e.g. X, is within an area e.g. Y, is as the following: the server can determine the parameter value of point X. The server can then determine the parameter values of all the points in area Y. The server then compares the parameter value of X to the parameter values of all the points in area Y. If the parameter value of X equals the parameter value to one of one of the points in area Y, point X can be determined as in area Y. An area can be defined by channel, zip code, city name, etc.

It is to the server's advantage if the server can limit the number of available pick up points users may select to as few as possible, although there may be many more pick up points available for selection. As an example, a seller has 100 customers in an area, called area A, and area A contains five available pickup points. If the server can direct the customers to use only three of the five pickup points to pick up their orders instead of using all the five available pickup points (assuming carrying capacity permits), the server can save operation costs. In an embodiment, the server may display (release) only a few, e.g., one or two, of the available pick up point(s) in an area for users' section. The users are then forced to select the displayed pick up points. The server may present (release) other pick up points in the area for user to select when the displayed pickup point reaches its maximum delivery capacity. A pickup point reaches its maximum delivery capacity when the mobile pickup station assigned to the pickup point reaches its maximum carrying capacity. If a pickup station at a pickup point is a FPS (Fixed Pickup Station), the pickup point reaches its maximum delivery capacity when the FPS reaches its maximum storage capacity. In one embodiment, a server establishes an order of releasing pickup locations for use. The server releases pickup locations in an area for buyers to use according to the order. The order may be decided by the demographic information, such as population density, in a target area collected by the server.

In the embodiment, the server first defines an area. The server then identifies the available pickup locations in the area and can secure the use of pickup locations by lease or acquisition. The server then collects the demographic information surrounding all the pickup points in the area. The server establishes the order of releasing pickup locations according to the information and releases pickup locations in the area according to that order. For example, the server may decide to use the traffic conditions around pickup locations in an area to determine the order of releasing pickup locations. In this case, a pickup location that is along a busy street with more traffic passing by is released for use before a pickup location that is along a slow street with less traffic. The server may release another pick up point in the area for use when the released pickup point reaches its maximum delivery capacity. Similarly, a pickup location that is close to a busy shopping center with more traffic is released for use before a pickup location that is close to a slow shopping center with less traffic. Similarly, a pickup location that is located in a region with higher population density is released for use before a pickup location that is located in a region with lower population density.

To display too many pickup points simultaneously to a buyer may be useless and confusing. In one embodiment of the present invention, the server determines the numbers of pickup locations to be displayed to a buyer to use. In the embodiment, the server selects a number “Y”. The server then calculates the closest “Y” pickup points to a user's selected identifier and releases these pickup points for the user to use. A user's selected identifier can be the user's home, office, telephone number, or the user's travel route, etc. In this embodiment, the MPS entity calculates the distance of every pickup point to the buyer's selected identifier and identifies the “Y” pickup points that are with the shortest distances to the buyer's selected identifier. The shortest distance may be defined by the straight-line distance method, the road-traveling distance method, or time defined distance method discussed before. The server may then display (release) these pick up points to the user. The server may decide not to display other pickup points to the buyer. Y may be any number. For example, Y may be one, two, three or four, etc. The server may determine the value of “Y”, i.e. the number of pickup locations to release, based on its experience. The server may allow a buyer to determine the value of “Y”, i.e. the number of pickup locations to release.

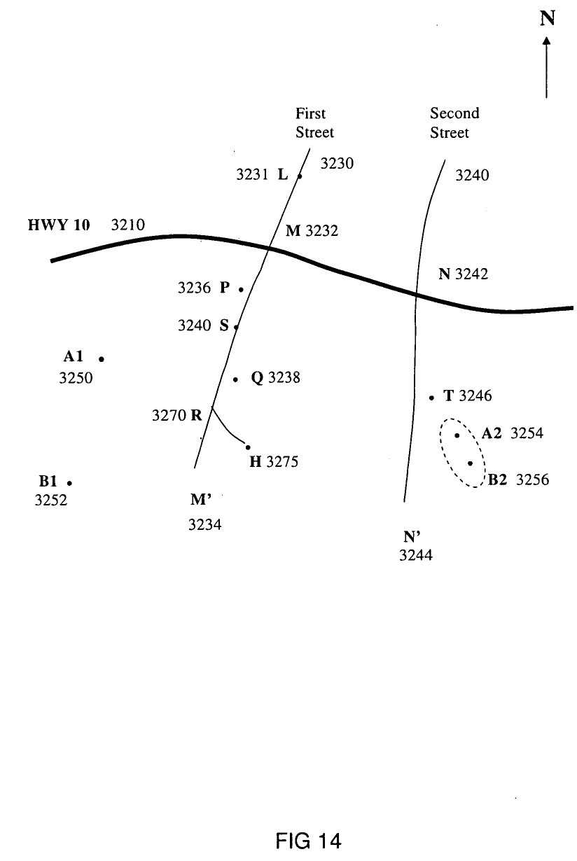

As has been disclosed earlier, a MPS server may assign a pickup point to a buyer for the buyer's use. In one embodiment, the MPS entity establishes a priority system and use the system to release (or assign) pickup points to a buyer. A pickup point with a higher priority rating is released to the buyer prior to a pickup point with lower priority rating. A pickup point is released to a buyer can mean: the pickup point is displayed to the buyer for the buyer's selection, or is assigned to the buyer by the server for the buyer's use. In one embodiment, a pickup point that is closer to a buyer's selected identifier is assigned with a higher priority rating. A buyer's selected identifier can be the user's home, office, telephone number, or the user's travel route, etc. In the embodiment, the MPS entity identifies all open pickup points and can calculate the distance of each open pickup point to a buyer's selected identifier. The MPS entity can release the open pickup point with the shortest distance to the buyer's selected identifier for the buyer's use. An open pickup point is a pickup point that has the capacity to accept the buyer's order. (In the present invention, the distance between any two points may be defined by the straight-line distance method, the road-traveling distance method, or travel time method as discussed before). An example of this embodiment can be found in FIG. 14. In that figure, Q 3238 is assigned to the buyer to use and not S 3240 or P 3236, because Q 3238 is the closest to the buyer's selected identifier, i.e. home H 3275. P 3236 has the highest priority rating. Assuming S 3240 is the next closest pick up location to the buyer's home. S 3240 may be assigned to the buyer to use when Q 3238 reaches its carrying capacity and is closed.

In another embodiment, the priority rating of a pickup point is determined by the order the buyer passes the pickup point when the buyer commutes. For example, in FIG. 14, Buyer A travels to his/her home H 3275 from work by using HWY 10 and exit M 3232. Buyer A passes pickup point P 3236 before he/she passes pickup point Q 3238. A pickup point the buyer passes later during his/her commute is assigned with a higher priority. For example, the MPS entity can assign a higher priority to Q3238 than to P 3236 when it releases pickup points to Buyer A. The MPS server releases a pickup location to the buyer to use according to its priority unless the pickup location is closed at the time the buyer places his/her order. In the embodiment, the sequence of pickup locations a buyer passes on the route of the buyer's commute can be determined as following: The server can identify a buyer's travel route and the pickup locations along the travel route. The server then determines the distance between a pickup point and a determined reference point. The determined reference point may be the buyer's travel origin or a highway exit such as M 3232. A pickup point that is along the buyer's travel route and is with a longer distance between it and the reference point is a later pickup point the buyer passes traveling from the reference point. For example, if the reference point is M3232, Q 3238 is a later pickup point compare to P 3236 and is assigned with a higher priority. In the embodiment, the pickup point that is along the buyer's travel route and is with the longest distance between it and the travel origin (e.g. office) is released to the buyer to use first unless it is closed at the time the buyer places his/her order. In another option of this embodiment, the release of a pickup point may be determined by the distance of the pickup point to another determined reference point. The reference point may be the buyer's travel destination (e.g. home H3275) or a point such as R 3270. Assuming R3270 is a point the buyer passes after P 3236 and Q 3238. The server can identify a buyer's travel route and the pickup locations along the travel route. The server can calculate the distance between a pickup point and the buyer's travel destination once their addresses are known. A pickup point that is along the buyer's travel route and is with the shortest distance between it and the travel destination (e.g. home) is released to the buyer to use unless it is closed at the time the buyer places his/her order.

When a new pickup location is established by the MPS entity, the MPS entity can use the above embodiments to find a new pickup point for a buyer to use. For example, in FIG. 14, if Buyer A is using pickup P 3236 and Q 3238 is a new pickup location. The server can use the above methods to determine the priority ratings of P and Q for Buyer A. If Q 3238 has a higher priority rating than P 3236 for Buyer A, for example, and Q 3238 is closer to Buyer A's selected identifier, the MPS entity can release pickup location Q 3238 to Buyer A. One advantage of this process is if a buyer, e.g. Buyer A, is moved to a new pickup point, e.g. Q 3238, a space in the original pickup point, e.g. P 3236, is opened. The space can be released to a buyer who lives close to the original pickup point. In this way, each buyer can use a pickup location that is convenient to him/her.

The server may allow a user to select a channel width to build a channel. Or, the server may select a channel width to build a channel for a user. The channel width may be defined by road-driving distance or straight-line distance or preferred traveling time. A channel width may be any number from zero to infinity, regardless of whether the server or the customer selects it. For example: a channel width may be ¼ mile, ½ mile, one mile, two miles, 5 miles, or 10 miles, etc. If a channel width is defined by traveling time, it may be 5 minutes, 10 minutes, 20 minutes, 30 minutes, or one hour, etc. The server can build a channel once a channel width is determined. The server can display pickup locations within the channel for selection.

The server may display other pickup points for a user to select if the user expresses dissatisfaction with the pickup point(s) displayed and wants other selections. The server may thus select any number of pick up points among the available pick up points for the user's selection as long as the estimated income derived from releasing a new pickup point will justify the cost of setting it up and operating it. The server may present different users with different pick up points for selection even though these users the same travel routes or use the same location identifiers. The server may assign more than one pickup station to a pick up point. If in an area (or in a route), there is only one pickup point that is available for a user to select, the user has to select that pickup point, if the user wants to use the server's service.

When a user forgets or ignores to select a channel width, the server may voluntarily display to the user a channel with a server selected channel width.

In another embodiment of the present invention, the MPS server may allow the user to enter more then one (i.e., two, three, four or more) identifier to identify the general area or localities the user wants pickup locations to be displayed. When building a travel route with multiple identifiers, the travel route is built in a way that connects all identifiers entered. A channel width may be selected by the user or set by server default.

Referring again to FIG. 1, after finishing input of all setup information, a buyer proceeds to step 140. The MPS server may display product categories for the buyer to choose if the buyer does not want to change any information at step 144. Product categories are different groups of products sold by a seller. For a food producing company (e.g., a food catering business or a lunch/dinner delivery business) the categories may be: drinks, wine, Italian food, French food, Japanese food, desserts, pizza or other products the server is selling. The MPS entity may ask its suppliers, e.g. a food producing company, to provide product information. The product information may include product specifications, features, prices, nutrition information, etc. The MPS entity may keep the product information in its database. The server may use this information and a buyer's preference information to screen for products a buyer prefers and displays only those products that match the buyer's preferences.

The MPS server may display only those categories that match the buyer's preference and disregard those that the buyer is not interested in purchasing. The buyer may click on the category he/she wants to purchase at step 146. The MPS server may bring up all products under category buyer selected at step 148. After screened by category, the products displayed may be subject to the same screening process as previously described, which is, only products that match the buyer's preference may be displayed and any other products may be disregarded. The MPS server may display product features along with products. Those features displayed may be ingredients, calorie count, fat count, and price, etc. The MPS server may also employ the technology that gives out the scent of the food when buyer reviews its product information to stimulate purchases. The buyer may cancel previous orders or, after reviewing product items, decide to order and continues to order mode at step 150.

In one embodiment, a MPS server provides an Automatic Selection Method (ASM) service. This is a MPS server service designed for a buyer who does not want to go through the trouble of ordering manually repeatedly and, after establishing the buyer's preferences with the MPS server, wants the MPS server to place orders for him/her according to the buyer's preferences. As an example, a buyer may set up a buyer's preference with the server. A buyer's preference may include the specifications, attributes or features of the products the buyer desires. As an example, a buyer's preference for a meal may contain less than 600 calories, fewer than 30 grams of fat, no red meat, no onion, be priced under $5.00 or have the total meal budget for a month lower than $250.00, etc. The user/buyer may decide if he/she wants to use the ASM method to order food at step 152.

If the buyer/user wants to use the ASM method to order food, the MPS server may follow the following steps to generate orders for the buyer: The MPS server may display a calendar at step 154. The buyer may mark on the calendar to indicate the day (or days) the buyer wants products to be delivered at step 156. The MPS entity then arranges to deliver the buyer's order at the day or (days) specified by the buyer.

The system allows a user/buyer to select one day or multiple days for service. Instead of checking the day (or days) for service, the system may allow the user to check those days the user does not want service to be provided, and the system orders service for those days the user does not check. The system may allow the user to enter other selection options, such as: service to be provided for every Monday and Wednesday only, every Monday, Tuesday and Friday only, service to be provided every weekday, service to be provided excluding or including holidays, or to be provided on any combination of days, etc. The calendar the server presents to the user may be in any form as long as a user may use it to identify the day or the days(s) he/she wants (or does not want) service. The calendar may be a traditional calendar, a list containing days, a drop down menu containing days or other forms. The server may also allow the user to enter from keyboard the day or the days the user wants or does not want services.

The server may collect a buyer's product preference information from the buyer. When the product ordered is food, the preference information may include specifications/attributes of the food product ordered (e.g. spicy/non-spicy food, vegetarian/non-vegetarian food, nutrition data . . . ), features of the food ordered, price of each order or budget (e.g. monthly, bi-weekly or weekly budget, etc) of total food ordered, nutrition information, etc. The preference information may include the foods a buyer dislikes or wants to avoid. For example, a buyer may reveal in his/her preference information that he/she is allergic to eggs and declares that eggs should never be included in the buyer's food. The information can be collected from the buyer by using a server-provided template. The server may design a template and use the template to collect buyer preference information. In the template, a number of questions related to the buyer's preferences may be presented. Examples of the questions may be: Does the buyer prefer spicy food? What price does the buyer want to pay for the order?, Is buyer a vegetarian?, etc. The buyer may use the template to answer these questions. Some questions may be answered in the form of ranges, such as preferred price being below $5.00, $5.00 to $10.00, or over $10.00, etc. Or a question may ask whether the buyer likes mildly spicy, medium spicy, or very spicy food. Some questions may be answered by checking yes or no. Some questions may be answered by typing key words to the template. The server collects this information.

The MPS entity may ask an entity to provide product information for these products sold through the MPS entity. The product information may include product specifications like those just mentioned. These product information provided to the MPS server is preferably in a format that conforms to or is compatible with the template presented to a buyer. The MPS entity may keep the product information in the MPS entity's database. The server may use this information to search for products that match the buyer's preference. The MPS server may display only those products that match the buyer's preferences to the buyer. The product information is preferably displayed in the same format as the template.

When the buyer wants to use the ASM method to let the MPS entity to order products for him/her, the MPS entity searches its database for a product that match the buyer's preference for the day(s) the buyer wants service. If the product is found, the MPS entity orders the product for the buyer. If a perfect match cannot be found, the server may search for a product with the closest resemblance to the buyer's preference. The MPS entity then orders the product for the buyer. The server may set up criteria and/or determination rules. The MPS entity uses the criteria and/or determination rules to determine if a product is resemble to the product the buyer wants. As an example, if a buyer lists five attributes for the preferred food product the buyer wants to purchase. A product, e.g. product A, has three attributes identical to the attributes the buyer's listed in his/her preferences. Product A may be regarded as closely resembling the buyer's preferences. Another product, e.g. Product B, has four attributes identical to the attributes in the buyer's preferences. If product B is the product with the most identical attributes, product B is used to fill the buyer's order. The server may generate an ordered list for the buyer. The ordered list contains the products ordered by the MPS entity according to the buyer's preference. The server may select a different product for the buyer for each day the buyer marks on the calendar that he/she wants service. In the embodiment, the MPS entity makes purchasing decision for a buyer according to the buyer's preference. The MPS entity arranges to deliver product to the buyer according to the days that the buyer wants service.

When the server generates an order, the server compares the order with previous orders. If an item in the order is a repeated item that was ordered before, the MPS selects a different item to fill the order. For example, when the MPS server generates an order for a buyer, one item in the order is a roast beef sandwich. The server may compare with the buyer's previous orders and finds out that a roast beef sandwich was ordered two days ago, the MPS server may replace the roast beef sandwich with another item. The buyer and/or the MPS server may decide a time period over which a repeated item is permitted. For example, the buyer may decide that he/she allows a repeated item every two weeks. In this case, the MPS service may select an item to fill the buyer's order two weeks after the day the item first appears on the buyer's order. In the example, when the server generates an order for a buyer, the server may review the buyer's order for the last two weeks to see if the item generated is a repeated item. If it is, the server substitutes the item with a different item.

The MPS entity may collect personal information from a buyer. Example of the information collected may be: the ethnic group the buyer belongs to, buyer's last name (an indication of ethnic group the buyer belongs to), buyer's religion, buyer's gender, or the buyer's address (to determine the vicinity the buyer is living in), etc. The MPS entity may project (or predict) a buyer's preference information based on the buyer's personal information. The MPS entity may use the projected preference information to place order for the buyer. For example, if the MPS entity finds out that a buyer's last name is of Muslim origin, the MPS entity may avoid ordering any food item with pork for the buyer unless the buyer indicates otherwise. If a buyer has placed orders from the MPS entity for a period of time and has established an ordering history, the MPS entity may analyze the ordering history and use this information to project the buyer's purchasing preferences.

The server may transmit the MPS server-generated order list to the buyer to see if the buyer wants to change any item (product) in the list. The MPS entity may give the buyer a specified time to respond to the list. If the buyer fails to change or cancel any item in the order list within the specified time, the order list is considered accepted and the MPS entity delivers the order according to its delivery date. The MPS entity may have an agreement with a buyer. In the agreement, an order that is placed by the MPS entity for a buyer by using the ASM method is considered ordered by the buyer personally and is considered a firm sales contract.

The entity may allow the user to place different orders and may have these orders delivered to different pickup locations at different delivery times in one day. For example, the user may order lunch and dinner on one day, and have the lunch delivered to pickup point A at 11:30 a.m. and have the dinner delivered to pickup point B at 5:30 p.m.

The buyer may choose to set different pickup points, and pickup times for each day as described in steps 112-138 (FIG. 2). In other words, the buyer is able to pick up his/her order at one pickup location on one day and pick up his/her order at a different pickup point on another day. Alternatively, the buyer may use a default route, pickup point or time information as previously entered in steps 158 and 160. The buyer may modify the buyer's preference if the buyer desires at step 162. The buyer may set up an “occurrence rate” for each product to appear on the buyer's menu at step 164. The occurrence rate is the percentage of times an item or an attribute of an item appears on the buyer's total orders.

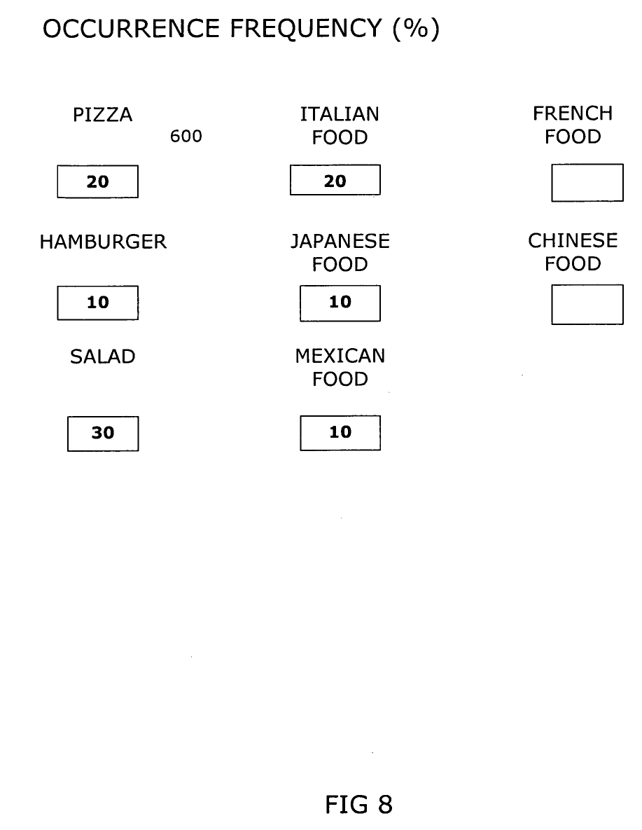

FIG. 8 is an example showing the use of a template to enter occurrence rates. In the example, a buyer enters a 20% occurrence rate for pizza 600. This means that the buyer wants 20% of the buyer's total orders to be pizza when the MPS server uses the ASM method to fill orders for him. In the example, if the buyer orders a total of 20 meals form the MPS entity, the ASM system will order 4 out of 20 of the buyer's meals with pizzas. (20×20%=4). The MPS server may generate an occurrence rate for a buyer based on the buyer's personal information such as: the ethnic group the buyer belongs to, buyer's last name (an indication of ethnic group the buyer belongs to), buyer's religion, buyer's gender or the buyer's address (to determine the area the buyer is living in), etc. As an example, if the MPS entity finds out that a buyer's last name is of Japanese origin, the MPS entity may set a higher occurrence rate of Japanese food for the buyer. That is, the ASM method may order a higher percentage of Japanese food for the buyer. If the buyer has placed orders from the MPS entity for a period of time and has established an ordering history, the entity may analyze the buyer's ordering history and use this information to project the buyer's the occurrence rate of a food item or an attribute.

Refer again to FIG. 1. In FIG. 1, the MPS server generates an order for the buyer. The server may set up a cut-off time. The buyer may be allowed to manually change a server-generated order before the cut-off time. If the buyer does not change the server-generated order before the cut-off time, the server-generated order is delivered at step 66. The server-generated order may be delivered according to the selected day(s) without buyer's further authorization, and the buyer can be liable to pay for these orders. As an example, if the server-generated order for buyer A on May 2 is a roast beef sandwich, the server may send an e-mail on the morning of May 2 to remind buyer A of the order. If buyer A does not reply, change or cancel the order by 1:00 p.m. of May 2, the order of roast beef sandwich can be considered firm and be produced and delivered. The buyer can then be liable to pay for the order.

If no change is made to the orders, the buyer may decide if the buyer wants to place orders in other categories at steps 168 and 170. If the buyer wants to place an order in another category, the buyer goes to category selection at step 146 and follows the same procedure as described before. If the buyer does not want to shop for any other categories, the buyer makes payments at step 172. The MPS server may regularly check buyer orders to see if there is any order or delivery that is due at step 174. If an order is due, the MPS entity prepares for production or makes inventory requisition for the order. The MPS entity prepares for all due orders.

A buyer may use the server-provided calendar to specify a production day and request that the order is produced on that day. The production date and the delivery date of an order may be set the same to insure the quality of the product.

Referring again to FIG. 2, the MPS server may collect buyers' names, pick up points, pick up times and other related information for due orders at step 176. The server then goes to its warehouse and gets access to its inventory. At this point, the merchandise items that are required by a buyer's order are in the server's warehouse. They may be unpacked, are unlabeled with the buyer's information, and are not ready to be delivered to the buyer. The server then retrieves all the necessary merchandise items needed in a buyer's order and collects them to fill the order. The server then packs and labels the buyer's order to a condition ready to be delivered to the buyer. The label contains the buyer's information necessary to identify the buyer.

In case there are multiple orders under a buyer's name, the server may first group orders by buyer name at step 178. The MPS server further groups orders by pickup points at step 180. At this time, all orders are grouped by buyer names and by pick up points and are in a condition to be loaded to a pickup station. A MPS is assigned to a pick up point. The MPS server may calculate the size of the orders to be shipped to a pick up point and assigns a MPS with enough capacity to execute the shipment at step 184. The MPS entity loads the orders to the MPS. The MPS, after being loaded with orders, is dispatched to the assigned pickup point at step 186. The MPS server may determine the timing of dispatching MPSs to pickup points. For example, if a MPS is needed at a pickup point at 4:00 PM and the MPS server also determines that the time spent on travel from the MPS server's warehouse to a MPS pick up point is about one hour, the MPS server may determine that the MPS should leave the MPS warehouse at about 3 PM.

A MPS server may send out a reminder to a buyer to remind the buyer to pick up the buyer's products at step 188. The reminder may be sent by e-mail, a telephone call to a buyer's cellular phone or office, or by sending a message to the buyer's Palm Pilot. The MPS server may use a Mobile Location Determination System (MLDS), Global Positioning System (GPS), car navigation system, cellular phone caller location determination system or other systems capable of determining a customer's current location for customers equipped with those technologies. Upon the detecting that the customer is near the assigned pickup point, the MPS may start to prepare the customer's order and/or send a message to the customer to remind the customer to pick up products ordered and provide the directions to the pick up point.

When a MPS arrives at a pick up point, the MPS stays there for the station time at step 190 and waits for buyers to pick up products at step 192. At this point, a buyer's order is in a condition that is packed, labeled with buyer information and ready to be picked up at a pickup location. The pickup location is convenient for the buyer to use. As discussed, the pickup location is selected by the buyer or is assigned to the buyer by the server. The server can assign a pickup location that is along a buyer's commuting route to the buyer.

In the case where the MPS is a locker kiosk without an operator or attendant, the station time may be longer than those stations with operators or attendants. The MPS may install a sign, fly a balloon, or turn on a search light for the buyer's easy identification. Also, a MPS may have microwave ovens for the buyer's convenience to heat up food the buyer picks up.

Referring again to FIG. 2, when a buyer picks up a product at step 192, the operator of a MPS may want the buyer to sign a receipt as evidence of receiving products. If buyer fails to pick up an order at step 194, the MPS operator may follow the buyer's instructions as to how to handle the products not picked up. A MPS server may give instructions such returning the products not picked up to a MPS warehouse for re-delivery or sell the non-picked up products for whatever the operator can sell and credit the buyer for the amount sold, etc. If the product ordered is a meal item and the order is not picked up, the order may be discarded after it is returned to the MPS warehouse because it is highly unlikely that the order can be re-sold. The server may decide that the buyer's orders can only be released from a MPS when the buyer or his/her representative personally appears at the pick up point pick up the order.

When the station time is up, the MPS may leave the MPS pick up point (or is picked up by MPS server) at step 196. The MPS station may leave the pick up point if all orders have been picked up, even if the station time is not up. For the maximum use of an MPS, it may be moved to another location to carry out other assignments at step 198.

If the buyer wants to order manually instead of using an ASM service to order at step 152 or if the delivery is not for the current day at step 153 and the selection of order is not complete at step 202, the MPS server may provide a calendar at step 204 for the buyer to select the days of order/delivery desired. The calendar displays a plurality of dates and allows the buyer to select multiple dates of service. For these days of service the buyer selects, the buyer may select for each date on the calendar a different order and the server relates each order to the selected day. The buyer may manually mark on calendar the days the buyer wants to order products and have them delivered at step 206, and the buyer fill those days with orders at step 208. The buyer may specify a different route at step 210 and pickup time at step 212 for each day by using the same procedure as described before.

If the manual selection of orders is complete at step 202, the buyer makes a decision as to whether the buyer wants to make other orders at step 170. If the buyer does want to make other orders, the buyer selects a category at step 146; if not, the buyer makes payments on the existing orders at step 172. If the buyer wants to order manually instead of using an ASM service at step 152, and if the order/delivery is for the current day at step 153, the buyer may go into the order mode and place an order at step 220. The buyer may change the route and pick up point at step 224, and pick up time at step 226 as previously described. The server may establish a cut-off time for every order placed by the buyer. The buyer may change or cancel an order before the cut-off time. If the order is not changed or cancelled by the cut-off time, the buyer is liable for payment of the product.

As previously described, a MPS server may display to a buyer available pickup points within or around the buyer's channel for buyer's selection. As described also, MPS server may display to the buyer available pickup points defined by other identifiers.

Several different methods may be used by a MPS server to determine available pickup points for a buyer's selection.

An Approximate Method may be used for selection of available pickup points. In the Approximate Method, the MPS server may use the traffic volume of a route (e.g. a highway, a street off-ramp to a highway or a major street) as a guide to approximate buyer route concentrations and place available pickup points along the route for usage selection. A highly-traveled highway and/or its off-ramp street may be assumed to have a high user route concentration and available pick up points may be placed along it. The same assumption may be made for a busy major street. The MPS server may thus present to the buyer pick up points along those routes for selection. Other criteria in determining available pick up points may be considered and will be disclosed later.

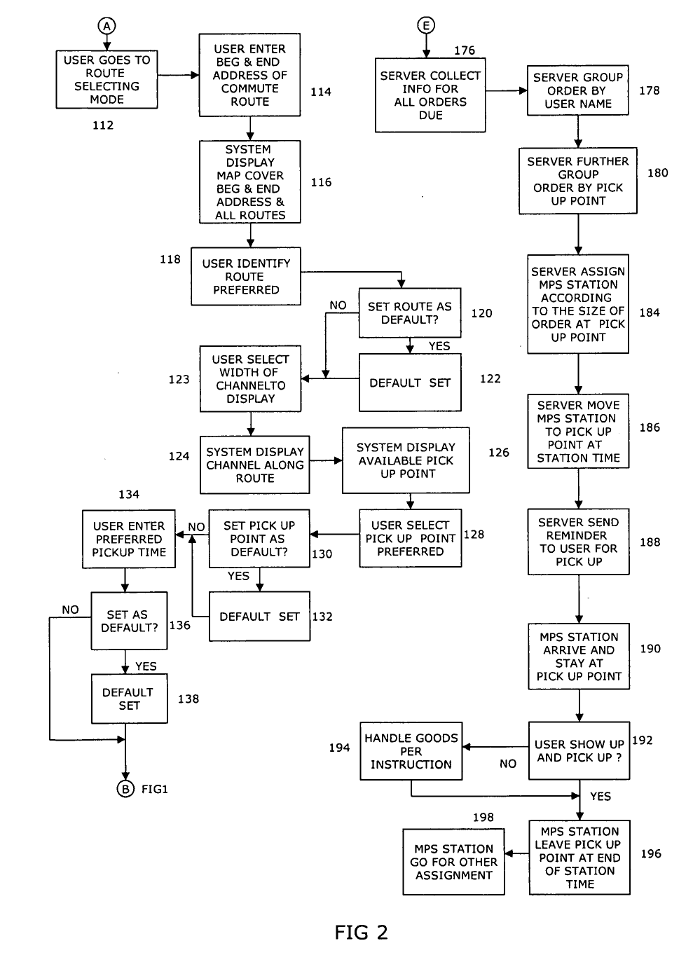

FIG. 3 is a process flow diagram of a method used by a MPS server for selecting available pick up locations using an overlap route method. In this method, the MPS server collects buyer chosen commute routes and/or channels from buyer input at step 300. The MPS server then overlaps all chosen routes without channel or all channeled chosen routes defined by all buyers at step 304. The MPS server may for every overlapped route or area select the overlapped route or area as an area for available pickup points at step 306. In addition to overlapping, the MPS server may consider other criteria for determining pickup points at step 308. Other criteria the MPS server might consider are if rent involved for using a pick up point, the amount of the rent, the distance of the pickup point from the buyer's route, convenience of the pickup point to a buyer's route, parking availability, pickup point easy identification, etc. The MPS server makes a decision and selects available pick up points at step 310. The MPS entity makes necessary arrangements, e.g. signs a lease with the property owner for the use of the pick up point. Once an arrangement is made, the MPS entity can add the pick up point to its database. The pick up point is then ready for selection.

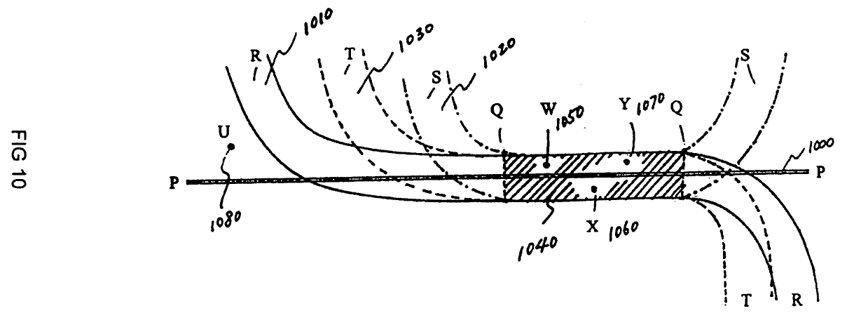

A buyer may choose his/her chosen pickup point and/or default pickup point among those available provided by the MPS server. The MPS server decides if current available pick up points would be able to satisfy users at 312. If it is, the selection of available pick up points is complete and goes to step 314. If the MPS server needs to provide more pick up points to the buyer, the MPS server goes to step 308 for more selections. The MPS server may change parameters to expand or contract the area of available pickup points at step 314. For example, the server may decide that it is no longer economically feasible to select an area to establish available pick up points if the area only contains a few user route/channel overlaps. The server may increase the parameter. From time to time, the MPS server may periodically review buyers' chosen commuting routes at step 316 to see if the buyer route distributions have changed. If the buyer route distributions have changed, the MPS server may correspondingly reposition its pick up points to better serve buyers. If the time for route reviewing is due at step 318, the MPS server restarts the whole process to update the MPS pickup point position at step 300. FIG. 10 is a graphical representation of a MPS pick-up point area assessment. Assume that PP 1000 is a route, e.g., a highway or a major street with heavy traffic. Buyers R, S, and T each have a buyer's chosen route. Buyer R has chosen route RR 1010, buyer S has chosen route SS 1020, and buyer T has chosen route TT 1030. Also assuming in the beginning, a MPS server does not have any route information pertaining to buyers R, S, and T, then the MPS server can only use an approximate method to choose a pickup point, for example, point U 1080. Under this method, buyers R, S, and T have to travel out of their chosen channels to get access to point U.

Assuming the buyer routes are available to the MPS server. The MPS server may overlap all chosen channels from all of the buyers to form an overlapped area QQ 1040. Area QQ may be qualified as a pick up point selection area because QQ is the area overlapped by multiple chosen routes, namely RR, SS, and TT. The MPS server may propose pickup points within this available pickup point selection area QQ to a buyer wishing to pick up a product.

Now assume that points W 1050, X 1060, and Y 1070 are locations inside area QQ that the MPS server considers as possible pickup points. Also assume that point W is a parking lot in a major supermarket, W is also close to route PP, and easily accessed from route PP. The MPS server may select W to be a pick up point after the MPS server considers all the criteria. Point W may then be presented to buyers R, S, and T and W may be chosen as a pick up point. A buyer may then abandon their original pickup point U and position the new pickup point at W. The MPS server may propose more than one available pick up point in an available pick up point selection area depending upon buyer route concentration, e.g., X or Y may be selected as available pick up points also, if the MPS server desires.

In one embodiment of the present invention, a MPS server acts as a third-party delivery MPS server. A third party is a business entity that does not provide MPS server itself and have an agreement with a MPS server to use the MPS server services to serve the third-party's customer. For example, a local flower shop may receive orders online from a buyer. The flower shop allows the buyer to access a MPS server operated by an entity other than the flower shop so that the buyer can use the MPS server to position a pickup point and pick up flowers ordered there. This flower shop is a third-party seller.

Sometimes a third-party seller's customer may already have a preferred MPS pickup point established with a MPS server because of previous orders with other companies. In this case, the third-party seller only needs to confirm that the buyer wants to use the MPS service to pick up flowers ordered. The flower shop may then make arrangements with the MPS server so that the flowers ordered may reach the pick up point for the buyer to pick up. The arrangements between the third-party seller and a MPS server concerning the shipment of products from the third-party seller to a MPS warehouse may take many forms and will be discussed in more detail later.

Upon receipt of the third-party's products, a MPS server may search to see if the buyer has other orders that can also use MPS service. If the buyer does have other orders, the MPS service may group all orders pertaining to the same buyer and use a single MPS to deliver those products to a MPS pickup point for pick up by the buyer.

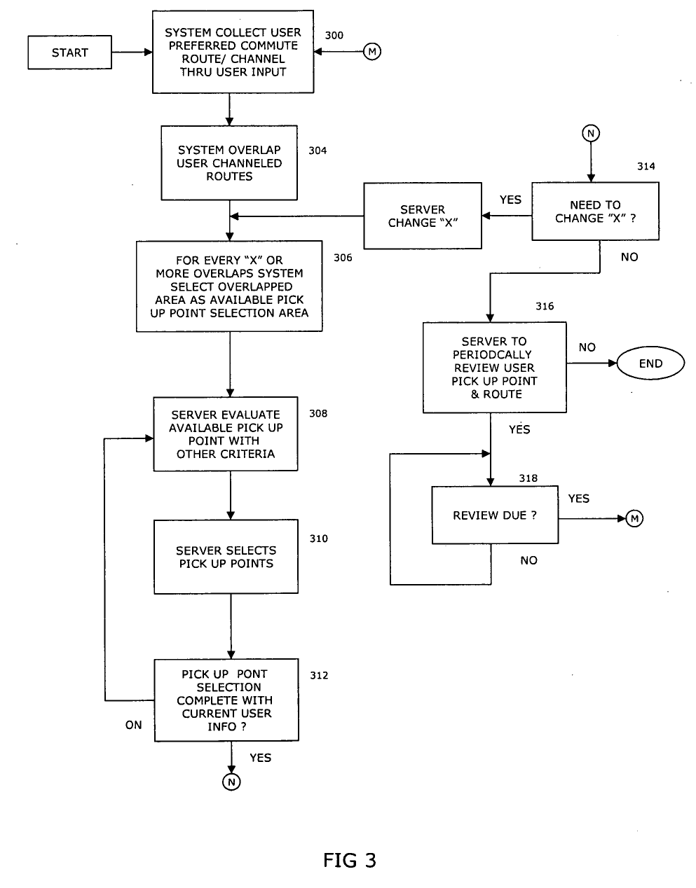

FIG. 4 is an example of a process flow diagram of a third-party seller ordering process. A buyer goes on the Internet at step 400, and goes to a third party's Website at step 402. The buyer creates orders at step 404, the buyer then makes a decision as to what delivery options the buyer will use at step 406. The buyer decides if he/she wants to use conventional delivery methods to ship his/her order, which usually involves shipment by common carriers (e.g. UPS or USPS), or uses a MPS service so that the buyer can pick up his/her order at a pickup point. Assuming the buyer wants to use a MPS service, he/she goes to a MPS server Web site at step 408. A link is established at the web page to connect the user to the MPS server.

At the MPS server website, the buyer may either set up to establish a pick up route and pick up point with the MPS server, or update route and pickup point information already established with the MPS server from previous purchases with the MPS server at step 410. The third-party seller keeps a record of the buyer's order together with all related shipping information. The user may be transferred back to the seller's website to complete some administrative details such as payment, etc.

The third-party seller may establish an order cutoff time, which is the latest time for order receiving. An effective cutoff time allows the seller enough time to pack and arrange ordered products to ship to a MPS warehouse before a MPS server dispatches to MPSs to pickup points. For example, assume a MPS leaves a MPS warehouse and then heads for a MPS pickup point at 3:30 PM. Also assume that it takes 30 minutes for the seller to process and pack orders, and it takes another 30 minutes for the products to be shipped to the MPS warehouse, the order cutoff time will be set at 2:30 PM. If a buyer orders before the cutoff time at step 414, the third-party seller then arranges the ordered products to be shipped to the MPS warehouse at 418.

There are various ways products can be shipped to a MPS warehouse, which will be disclosed later. Once ordered products are shipped to a MPS warehouse, the products are loaded onto a MPS and then the MPS moves to a MPS pickup point at step 420 and waits for buyers to pick up products at step 422.

In the case where a buyer orders after the cutoff time of 2:30 PM, as set in the above example, the third-party seller may impose an extra delivery fee to deliver the order to a preferred pickup point, and the buyer can pick up the order at that pick up point. In this case, the third-party seller logs on to a MPS server. The MPS server displays a map that covers the third-party seller's location and the buyer's route at step 424. The MPS server also displays the buyer's default pick up point and other available pick up points near the route. The seller selects a pick up point for delivery at step 426 and quotes the buyer the price of delivery to that pick up point. If the buyer agrees with the quotation and other terms at step 428, the products are delivered to the specified pick up point for buyer to pick up at step 422. If no pickup point is satisfactory to the buyer, other arrangements have to be made at step 436, or the sale is cancelled at step 434.

As previously noted when discussing step 418 of FIG. 4, various arrangements for the shipment of products from a third-party seller's store to a MPS warehouse may be made. These arrangements may take many forms.

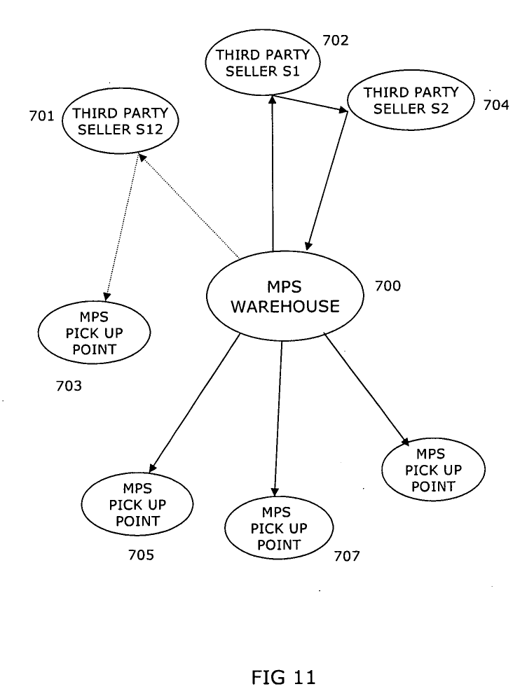

In one embodiment of a MPS server, as illustrated in FIG. 11, a MPS warehouse 700 may send out transportation equipment, e.g., MPSs, to the warehouses of a third-party seller S1 702 and a third-party seller S2 704 to pick up products ordered by buyers. The MPSs then go back to the MPS warehouse for packing and processing. The MPSs can be dispatched to pick up points such as 705 and 707 with user orders loaded. A MPS can, after picking up orders from third party sellers (e.g., S12 701), go directly to a pickup point, e.g. 703, for users to pick up goods ordered.

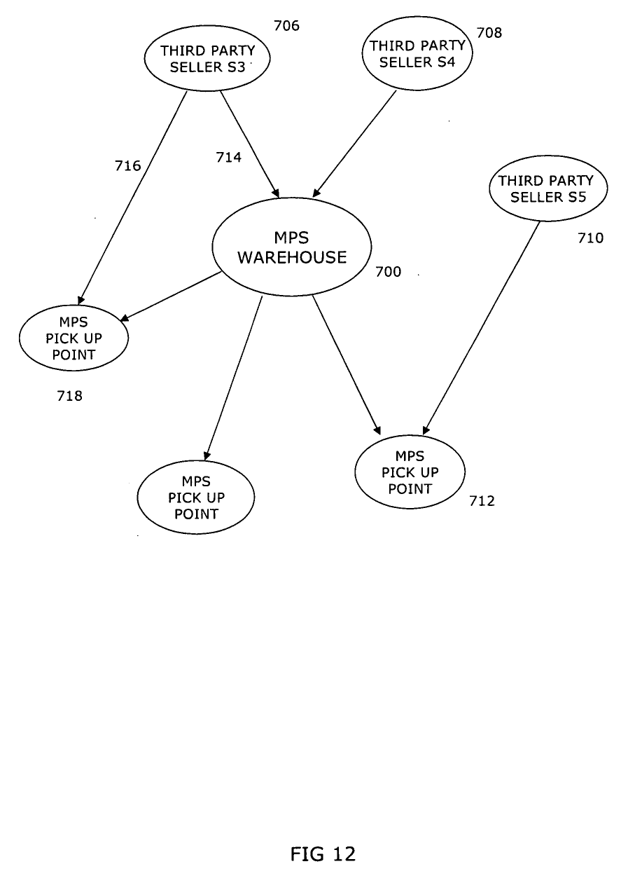

In an alternative embodiment of a MPS server, as illustrated in FIG. 12, a third-party seller S3 706 and a third-party seller S4 708 may ship buyer-ordered products to a MPS warehouse 700 by their own transportation means or by common carriers for further distribution. S5 710, another third-party seller, which is local to one of the pick up points 712, may choose to ship buyer ordered products directly to the pick up point 712. A MPS that stays at pickup point 712 receives the products and waits for a buyer to pick up the products. Third-party seller S3 may use route 716 to deliver a portion of orders directly to a pickup station 718 and at the same time deliver another portion of orders to the MPS warehouse 700 for further distribution.

The MPS with stations at 712 may be a movable trailer or a movable kiosk. A second MPS station may ship buyer orders to the MPS station and loads these orders to the MPS. The second MPS may leave the pickup point, and the MPS will house the orders and waits for buyers to pick up these orders.

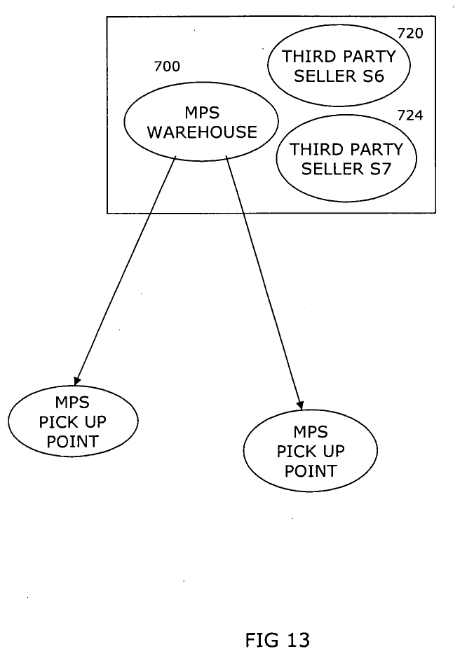

In another alternative embodiment of a MPS server, as illustrated in FIG. 13, third-party seller S6 720 and third-party seller S7 724 may be at the same location with a MPS warehouse 700. Orders may then be transferred to a MPS distribution center. The third-party sellers may be different entities that share the same warehouse or they may be different divisions that belong to the same entity. In this model, because the third-party sellers are so closely located to each other, the order cutoff time can be close to the time MPSs are dispatched to pick up points.

One embodiment of a MPS server provides for a channeled route search method in which the MPS server utilizes the commuting route and channel building technique previously described to carry out searches for products buyer wants to purchase. For example, a buyer wants to buy a car battery so the buyer goes to the Internet and logs on to a MPS server in search mode. The MPS server displays a map. A buyer may click or depress and drag the buyer's mouse on the map to define a route. The buyer may further define a width of a channel to form a channeled route and may search within this channel for stores that carry the products the buyer wants to purchase.

Referring again to FIG. 7, the buyer, through clicks or drag of mouse defines route 570. Assuming the buyer wants to search for a store with ¼ mile distance along the buyer's commuting route, the user sets a channel-width size of ¼ mile. The MPS server displays a channel 572 with boundaries 578, 580. Each boundary is ¼ mile apart from the route 570. The MPS server will later search to see if there are any stores within the channel that carry the product the buyer wants. The MPS server accesses a database that contains stores with information such as name, products carried, product price, address (with zip code), and telephone number, etc.

The MPS server first determines all the zip codes that are covered by the channel. A zip code is covered by the channel as long as any portion of the zip code area is within the channel. For example, zip codes 92001 and 92003 are covered by channel 572. Zip code 92005 and 92009 are not. The MPS server goes to a database to search for all stores that carry car batteries with zip codes 92001 or 92003. All the car battery carrying stores with zip codes 92001 or 92003 are selected for the next test, and those stores with other zip codes, e.g., 92005 or 92009, are disregarded. If no stores are found in this search, the buyer may change the width of channel or change the buyer's selected route to launch another search. If there are stores that carry car batteries with channel-matching zip codes (i.e., with zip codes that match 92001 or 92003), the MPS server saves these stores in memory and goes to the next step.

The MPS server searches for all the street names covered by (or within) the channel. Any street name or avenue name is covered by (or within) the channel as long as any portion of the street or avenue is inside the channel. For example, the channel covers Texas Street 592 and also Robinson Ave 594. The MPS server compares all the street names within this channel to the street name of those stores with matching zip codes selected from above step. At this stage, all car battery carrying stores, with matching zip codes and with street names matching any of the street names within the channel are selected for the next test and the others are disregarded. For example, after the zip code test, all stores with street names such as “Hawthorn Street” 582 are disregarded and all stores with street names such as “The 31st Street” 584, Texas Street 592 or Robinson Ave 594 are selected for the next test. This is because Hawthorn Street is not covered by the channel, but 31st Street and Texas Street are. Again, if there is no match found, the buyer can either enlarge the width of the channel or change the buyer's commuting route to launch another search.

If there are stores that match the above tests, the MPS server goes to the next step. The MPS server, after the buyer defines the width of the channel, can determine the street numbers (or street addresses, as sometimes called by people) at the boundaries of the channel. That is, the MPS server can determine the street numbers of points such as M 588 and N 590. The MPS server then determines if those matching stores from the above steps have street numbers that fall between the boundary points such as M and N. If a store does have a street number that falls between boundary points like M and N, the store is selected and is presented to the buyer; if not, the store is screened out and disregarded. For example, suppose the MPS server determines the address number of M 588 is 2002 31st Street and the address number of N 590 is 1800 31st Street, then a store with street address number 1900 31st Street will be selected and a store with address 2300 31st Street is disregarded. If no store is selected, the buyer can modify channel width and commute route to perform another search. After the buyer finds the stores that carry products the buyer wants to buy using this search method, the buyer can go to the store's web site and place the order. The buyer then decides whether the buyer wants to use a MPS service for pick up. If the buyer chooses to, the MPS server goes to step 406 (FIG. 4) and continues the procedures as previously described.

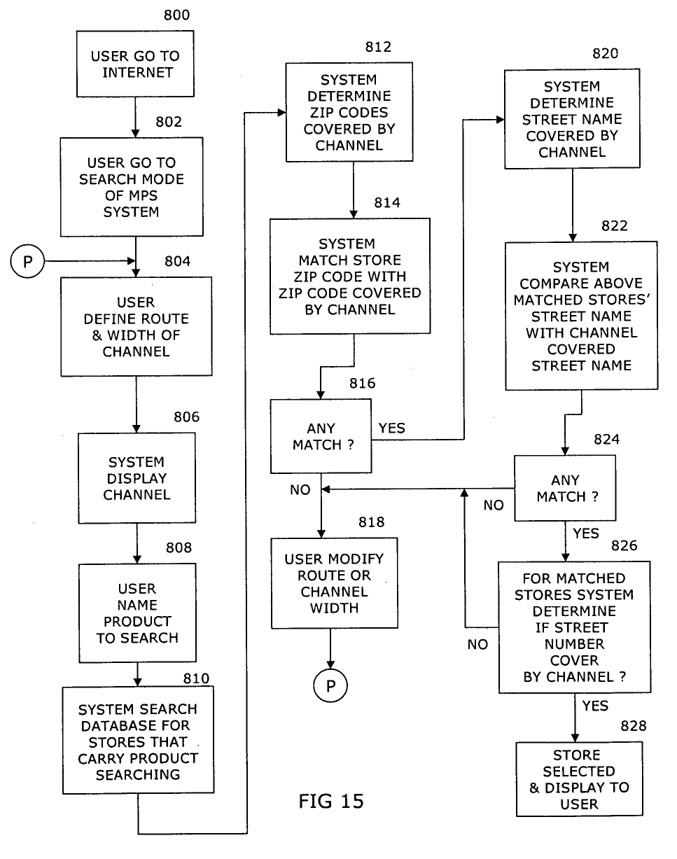

FIG. 15 is an example of a flowchart presentation of the above search method. A buyer uses a Web browser to access a MPS server at step 800. The buyer enters a channel search mode at step 802. The buyer defines a route and a channel as previously described in step 804. The MPS server displays the channel to the buyer at step 806. The user selects a product to search for at step 808. The MPS server searches a store database for stores carrying the requested product at step 810. The MPS server determines channel zip codes covered by the channel as previously described at step 812. The MPS server matches the channel zip codes found in step 812 to store Zip codes of stores found in step 810. The MPS server may determine if any store zip codes match any channel zip codes at step 816. If no matches were found, the buyer is invited to modify the search parameters at step 818.

If the MPS server determines that there are matches between the channel zip codes and the store zip codes, the MPS server determines the street names covered by the channel in step 820. The MPS server matches store street names to channel street names to determine if a store might fall within the channel at step 822. If there are no matching store street names and channel street names, the buyer is invited to redefine the search parameters at step 818.

If the MPS server determines that there are matches between the channel street names and the store street names, at step 826, the MPS server determines if a store street number is within the channel boundaries previously described. If there is a store street number within the channel boundaries, the MPS server displays the store to the buyer at step 828. If there are no store numbers within the channel boundaries, then the MPS server invites the buyer to redefine the search parameters at step 818.

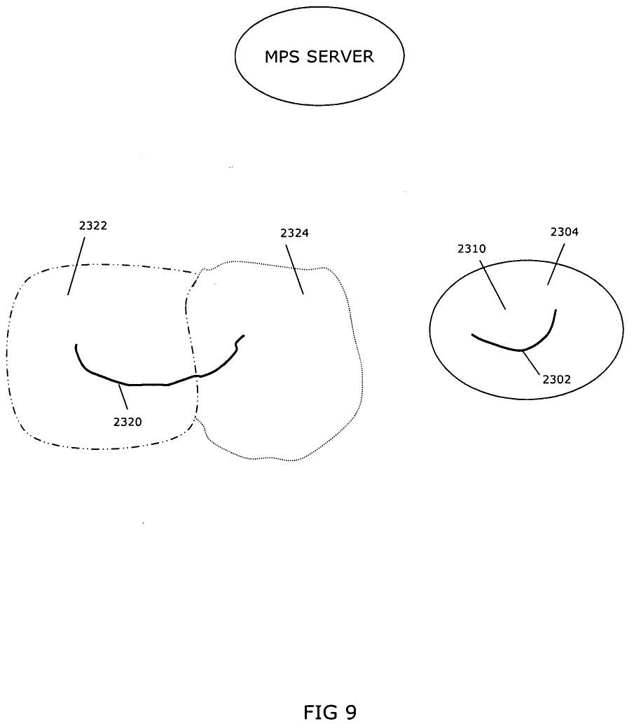

Referring now to FIG. 9, in a MPS server in accordance with an embodiment of the present invention, the MPS server is operated with multiple MPS warehouses. In this embodiment, each warehouse covers its own territory. The buyer/user goes to a MPS web site, inputs the beginning and ending address to define his/her route. The user may use other information such as zip codes, telephone numbers or landmarks to define his/her route as described before. The MPS server, according to this user route information, determines the territory that serves the user. For example, route 2302 is covered by territory 2304 that is assigned to warehouse 2310. A user route may be covered by more than one territory; for example, route 2320 is covered by territory 2322 and territory 2324.

In one embodiment of a MPS server, a buyer specifies another party to pick up the buyer's products. The buyer can change the pickup point of an order to a pickup location the pickup party prefers. The buyer can also specify the name of the pick up person and request that a MPS operator check the ID of the person who picks up the product to ensure proper pick up. In the case where the MPS is a locker kiosk including a plurality of lockers, the buyer can pass the code that is used to open the locker to the receiver, so that the receiver can open the locker to take the product out. In the case where the MPS server is operated by an entity that engages in the business of delivery or transportation, the service that the MPS server provides is the transport of the buyer's product or packages to a pick up point the pick up person desires and waits for the pick up person to retrieve them.

In one embodiment of a MPS server, the MPS server establishes Fixed Pickup Stations (FPSs), which are fixed structures such as buildings or offices that have the capacity to store user orders. For example, there may be stores, e.g., gasoline stations, convenience stores or super-markets, etc. that are located within the previously described available pickup points selection area. The MPS server may wish to contract with these stores to be pickup stations for MPS buyers. If a MPS entity reaches an agreement with such a store, the store becomes a FPS and may be one of the pickup points that are available for MPS buyers to select as pick up points. The server may then display these FPSs the same way it displays MPSs for the user's selection. After a user selects the FPS he/she wants his/her order to be shipped to, the MPS server may arrange for products ordered by buyers to be shipped to the FPS. Each FPS station may be used as a pick up point as well as a drop-off point, the same way a regular MPS can.

In another embodiment of the present invention, the FPS is equipped with temperature control equipment such as refrigerator, freezer and heater to store food products. In another embodiment of the present invention, the FPS is equipped with at least one cooking implement for the FPS operator to cook or prepare a user order. The server may select to equip a FPS with any one or more of the following cooking equipment, such as an oven, microwave oven, stove, sink, water supply, gas supply, or any other cooking equipment. In operation, the server may display FPSs, and the user may select a preferred pick up point (a FPS in this case) following the same process as a MPS pick up point selection as described. The server may then ship the food that a user ordered (fully cooked, partially cooked or uncooked) from its central kitchen to the user-selected FPS. The user may then pick up his/her order at the selected FPS.

A MPS may be a receiving station as well as a drop-off station. A drop-off station is a station where a user submits packages to the MPS personnel the user wants the MPS service to ship to a receiver. The MPS server, after receiving packages dropped off from the user, ships the packages back to a MPS warehouse for distribution. After distribution, the packages may be shipped to a MPS pickup point that is convenient to the recipient. In the case where a MPS server is a delivery or transportation business entity, such as FedEx, a MPS can be used as a pickup station for designated recipients to pick up their packages. A MPS can also be used as a drop-off station for users to drop the packages they want the MPS server to ship to the package recipients. Again, after a MPS receives such packages from a user, the MPS will ship the packages back to a MPS warehouse for distribution.

If the user fails to pick up his/her order in time, the operator of the MPS server may decide that it will ship those products back to the same pick up point for the user to pick up again. The user may not want to change the password and the locker that stores the order. The operator of the MPS server may establish a policy that allows users to pick up products within a determined number of days. Beyond this predetermined period, the product may be returned to the sender or handled in a way according to the operator of the MPS server's policy.

Referring again to FIG. 4, when a user/buyer goes to a third party seller's web site and purchases online 404, the user decides if the user wants to use MPS service as a delivery method 406. If the user wants to use MPS delivery service to pick up his/her order, he/she may go to step 408 to get access to the MPS system and then select a pick up point. The significance of step 408 may be explained by the following example: when a user goes to a third party seller website, e.g., Amazon.com, to purchase goods, the user must tell the third party seller, i.e., Amazon.com, the address where the order is to be delivered. Amazon.com then uses this address to prepare shipping label. A shipping carrier then ships the order to the shipping address according to the shipping label. During the process, the user must know the delivery address beforehand. However, in the case where the user wants to use the MPS service and to have the MPS system ship his/her order to a pickup point, it is highly likely that the user may only know the general locality of the pickup point and not its exact street address. This prevents the user from providing the shipping address to the third party seller. To solve this problem, a link may be installed at the third party seller's web page so that the user may be linked (transferred) to the MPS system. In the MPS system, a pick up point may be selected. Once the pick up point is selected, the address of the pick up point is then transmitted back to the third party seller system so that the third party seller may be informed about the address of the selected pick up point and may use the address to prepare the shipping label. The selected pick up point where the user may pick up his/her order is established in step 410. Pickup time may be established in step 410 also.

It should be noted that throughout the present invention, the server may present various identifiers, such as route, channeled route, zip code, telephone, landmark, etc. to define a pickup point. The MPS server may provide any one of the following identifiers, such as route, channeled route, overlapped route, overlapped channel, address with channel, zip code, telephone number, city name or landmark, etc. to a buyer so that the buyer may identify the preferred area of picking up his/her order. The server may display these available pick up point(s) defined by the area to the user. The user may select a preferred pickup point for picking up his/her order or, as an option, the server may select a pickup point for the user to pick up his/her order.

### Food Delivery Service

In another embodiment of the present invention, a MPS station, may be a vehicle, a kiosk or a trailer, is equipped with refrigerator(s) and/or food heating device(s) to carry or store food products. The MPS may further be equipped with microwave oven(s) to cook or reheat the food it is carrying for the customer to pick up.

The MPS server may have a business relationship with one or more Brand-Name Food Providers (BFP) such as Red Lobster, Chili's, Mimi's Café, and incorporate these BFPs' products into the MPS delivery service. A BFP is a food service provider, such as a restaurant, that sells its food products using a brand that does not belong to the MPS server.

All the methods, processes, and procedures disclosed in the present invention, such as ASM method, route selection, channel selection and pickup point selection can also be applicable to BFP customers and their orders. Note that in the present invention, it is possible for a customer to order food from multiple BFPs yet conveniently receive all the orders at one pickup location. For example, the customer may order steak from restaurant A and a seafood platter from restaurant B and receive all orders at once when he/she arrives at the selected pickup point. Restaurants A and B are both in business relationships with the MPS server as BFP members.

The MPS server may operate a website. The MPS server may designate a section of its website to a BFP. A customer may log on to the MPS server's website and click on a BFP icon to get access to the BFP's product menu. The product menu may be a drop down menu that contains a list of the BFP's products, or it may be a webpage that displays the BFP's products. A BFP may constantly update the product menu. The products may be disclosed with product specifications and pricing information. The customer may click on a product to order it. As an alternative, the MPS server's website may contain a link that connects a customer to the BFP website. The BFP website displays the product information, and the customer may place an order for the product at the BFP website. Here, a customer may decide if he/she wants to use the MPS delivery service to pick up orders. The customer may be transferred to the MPS server's website at the conclusion of their order process by clicking on an icon on the screen. At the website, the buyer may use MPS service to select a MPS pick up point.

There may be at least two options a customer may use to get access to a BFP's (or a third party seller's) product. The first option is that the MPS server may list a BFP's products or a third party seller's products on the MPS website and a customer may order the seller's product on the MPS server's website. As a second option, the MPS server's website may contain a link, which connects the customer to a BFP or a third party seller's website; the customer may then place an order on the BFP's website or the website of another third party seller.

In the first option, the customer may select a BFP's or a third party seller's product through a product list or product catalog presented on the MPS server's webpage. The third party seller or BFP constantly updates the product list or product catalog. After the customer completes his/her order, the order information such as the customer's name, product ordered, MPS pickup point information, pickup point address, product preferences, etc. is transmitted to the BFP or third party seller by fax, telephone, or the internet. The BFP or the third party may use this information to produce the order and prepare the shipping label. The shipping label, which includes the customer's name, pickup point address (or pick up point ID code), and other information, is attached to the order by the BFP for delivery and for identification after the BFP packs the order. The BFP is the producer of the order.

The server may display available pickup points for a customer's selection by using a map or by using a list. The customer may click on a pickup point to identify which pickup point the customer wants to use. The server then finds the address of the pickup point and relates this address to the customer's order. The server then transmits the pickup point address information together with other order information to the BFP or third party seller for preparation of shipping label. The shipping label designates the select pickup point as shipping address. The BFP or the third party seller then produces the order, packs the order, and attaches the shipping label to the order. The BFP or the third party seller may fully pack the order to the point that it is ready to be picked up by the customer, i.e., it is sealed, boxed, labeled with shipping label, etc.

In the second option, the customer is connected to a BFP's or a third party seller's website from the MPS website. The customer may place an order in the BFP's or the third party seller's website by clicking the product icon on the BFP's or third party's webpage. After placing the order at the BFP's or the third party seller's website, the customer may be sent back to the MPS server website to complete other details such as making payment or determining pickup points, etc. The BFP or third party seller collects all necessary order and delivery information to produce customer orders, prepare shipping documents, and shipping labels. A shipping document and a shipping label both contain shipping address information. The shipping address is the address of the selected pick up point an order is supposed to be picked up.

A supplier, e.g. a BFP or a third party seller, may be responsible for preparing a customer order (e.g. cooking or retrieving the order from inventory), packing, boxing, sealing and/or labeling to the point that it is ready for pick up by the customer. A supplier of a meal order like a BFP may pack all orders and affix the shipping labels to corresponding orders in its store for a MPS to pick up.

After production, orders may then be arranged to be shipped to a MPS distribution center and distributed to pick up points by using arrangements described in FIG. 11, FIG. 12 or FIG. 13. For example, the MPS entity may send out a MPS to a BFP to pick up products produced by the BFP. After the MPS collects orders from the BFP, the MPS returns to a MPS entity distribution center for order processing and order distribution. Orders can be unloaded and grouped by pickup points and buyer ID or buyer name. Each MPS is assigned to a pickup point. Orders that are to be delivered to the pickup point are loaded to the corresponding MPS. The MPS is then dispatched to the pickup point waiting for orders to be picked up. The MPS server may make pre-arrangement with a BFP (or third party seller) and set up a time to pick up the order from the BFP or third party seller. The MPS server may dispatch a MPS to the BFP or third party seller on or after that time to pick up the order.

In another embodiment, orders are not shipped to a MPS warehouse for distribution. A MPS picks up orders from BFPs and carries the orders directly to the corresponding pickup point for pickup. The MPS stays at the pickup point to allow customers to pick it up.

If an order is a food item, the order needs to be stored within a proper temperature range. Because a MPS may be equipped with proper equipment to store food and most passenger cars are not, a pickup point that is close to the customer's home may selected to avoid long exposure of the food item to room temperature. In this case, an identifier based on a customer's home, like the customer's home zip code or the customer's home telephone, may be used for pickup point selection. The server may then select a pickup location for the customer to use based on the distance between the customer's home and a pickup location. For example, the server may compute the distances of all available pickup locations to the customer's home, select a pickup location that is closest to the customer's home, and deliver the customer's order to the pickup location for the customer to pickup. The proximity of a pickup location to the customer's home may be defined by straight-line distance, driving distance or traveling time as discussed previously.

In one of the features of the invention, a customer can place different orders to different BFPs and can receive all products from these BFPs in one visit to a single pickup point. Using this feature, a customer does not need to travel to all the BFPs where he/she placed orders individually.

In one embodiment of the invention, a food service provider, like a restaurant or a BFP, sells its food products by using the MPS delivery service to increase its sales. The food service provider may use an outside party to deliver its food. The outside party operates a fleet of MPSs and delivers food with the MPS delivery methods described in the invention. Another option would be for the food service provider to operate a fleet of MPSs of its own and use the MPS delivery method to deliver its foods.

In one embodiment of the invention, a property owner, such as the owner of a gas station, leases his/her property to a MPS delivery entity to increase his/her income. The MPS delivery entity uses the MPS delivery methods described in the invention to deliver customer orders and uses the property as a pickup location. The property owner can benefit by leasing his/her property to a MPS entity to be used as a pickup location. One of the benefits is the rent received.

In one embodiment of the invention, an entity participates in a franchise activity and becomes a franchisee of the franchise activity to make a profit. The franchise activity uses the MPS delivery methods described in the invention to deliver customer orders.

In one use of the present invention, a customer places its order for foods and the order is passed to a production unit. The production unit may belong to a MPS entity, a BFP, or a third party entity. The production unit then retrieves the raw materials (ingredients) that are needed to produce the order from its inventory and prepares the order. After the order is cooked, the production unit packs the order with a packing label that contains the customer's information. At this point, the order is then packed into a condition suitable for delivery. The MPS entity then identifies the pickup location where the order will be picked up. The pickup location is a place that is convenient to the customer. The MPS entity then arranges a temperature controlled MPS to deliver the order to the pickup location. The order stays at the pickup location waiting for the customer to pick it up. During the process, raw materials are prepared into a final product that is consumable by a customer. The final products are packed and labeled, and are shipped to a place that is convenient for a customer to pick it up.

The following are other embodiments in the present invention:

I) In another embodiment of the present invention, orders are accepted and delivered with “No Tips, No Delivery Fees, and No Minimum Orders”.

In one embodiment of the present invention, a large number (e.g. in the hundreds) of meals are delivered to a single pickup location waiting for pickup. These orders are not delivered door to door to their buyers. Delivery costs (such as fuel costs, driver wages, and depreciation) are thus reduced. Because the MPS entity delivers many meals to a single location, the delivery carrier can reduce the delivery costs and spread driver wages, fuel costs, depreciation among all orders. In doing so, delivery costs per sales dollar or per order are low. Therefore, the MPS entity can afford to absorb delivery costs and may deliver meals to a buyer without any delivery fees. In this embodiment, a MPS entity can institute a “No Delivery Fee” policy. Under this policy, a customer order will be accepted and delivered without delivery fee charged to the customer by the MPS entity (the deliverer) or by the seller of the food regardless of the total price of the order and/or the quantity of the order. Under this embodiment, a customer order can be accepted and delivered without delivery fees charged to the buyer even though the order contains only one ordering unit of the lowest-priced item sold. Here, one “ordering unit” of an item is the basic unit to order the item (such as “a can” of Coke or “a bag” of potato chips). An order for an item must contain at least one ordering unit of the item. Under this embodiment, the price a buyer pays for a product with the MPS delivery service can be the same as the price the buyer pays when the buyer purchases and receives the product in the seller's store.

In another embodiment of the present invention, a MPS driver is compensated with a higher salary than the salary of a driver of a conventional meal delivery business. In the conventional meal delivery industry, a driver is typically paid with minimum wages and relies on tips from a buyer as compensation. As discussed, in an MPS operation, a large number (e.g. three or four hundreds) of meals are delivered to a single pick up location waiting for pickup. Because orders are delivered in large quantity, the MPS entity, when acting as a delivery carrier, may spread its driver's wages to all orders and can afford to pay its driver a higher salary. Because a MPS driver, is paid a high salary his/her employer, the driver does not need to collect a tip from a buyer and can earn a good income. In the embodiment, a “No Tip” policy is established by the MPS entity. Here, a “Tip” is compensation received by a delivery person from a buyer of a product for the delivery service the person provides. Under the “No Tip policy”, a customer order is accepted and delivered with no tips received, or expected to be received, by a delivery person regardless of the total price of the order and/or the quantity of the order. Also, under this policy, no tips are charged to a buyer by the delivery entity or by the seller regardless of the total price of the order and/or the quantity of the order. In the embodiment, a customer order is accepted and delivered with no tips to be received, or expected to be received, by a delivery personnel even though the order contains only one ordering unit of the lowest-priced item sold. Under the “No Tip” policy, a delivery person employed by a delivery entity only receives (or expects to receive) compensation for deliveries from the entity employing the delivery person. The delivery person does not receive (or expect to receive) compensation from the buyer.

In the MPS delivery model, orders with the same pickup location are aggregated, i.e. are placed into the same mobile pickup station, and are dispatched to the pickup location for pickup. Because all orders stay at a location waiting for pickup, the incremental cost of delivering an extra order is near zero. The MPS entity can afford to deliver an order even if the sales price of the order is very low. In one embodiment, the MPS entity establishes a “No Minimum Order” policy. Under this policy, a customer order is accepted and delivered regardless of the total price of the order and/or the quantity of the order. Under the “No Minimum Order” policy, a customer order is accepted and delivered even though the order contains only one ordering unit of the lowest-priced item sold through the MPS service.

In a businesses where a “Minimum Order” is required, the total price of an order is compared with the minimum order. If the total price of the order is less than the minimum order, the order is rejected. Under the “No Minimum Order” policy, a price check that compares the price of the order with a Minimum Order requirement is not necessary.

The elimination of minimum order requirements increases the customer base of the MPS entity.

To establish a meaningful minimum order requirement, the amount of the minimum order must be higher than the unit price of the lowest-priced item sold. If a seller allows a buyer to place an order that contains only one ordering unit of the lowest-priced item sold, then there is no need to establish a minimum order requirement. For example, if a merchant establishes a minimum order requirement of $4.00 and the lowest unit price of an item sold is $5.00, a minimum order requirement of $4.00 is unnecessary and meaningless. In this example, a meaningful minimum order must be higher than $5.00.

The “No Minimum Order”, “No Tip”, and “No Delivery Fee” features may be included in a written policy and announced to the public. The policy may be summarized as follows: no orders placed to a BFP through the MPS entity are subject to minimum order requirements, no buyers are charged with delivery fees (either by the deliverer or by the seller), and no delivery personnel (i.e. MPS truck drivers) expects to and/or are allowed to receive tips. In addition, no delivery fees are transferred and charged to a BFP.

Because of the nature and the cost structure of a MPS operation, a MPS service can establish the no delivery fee, no tips and no minimum order policies on a long-term or permanent basis and not for temporary promotion purpose. A program is for temporary promotion purpose if the revenue received from selling the service or goods during the life of the program does not justify the cost of the service or goods. A MPS entity can offer its services and products with “no delivery fee, no tips and no minimum order” with no expiration date, which means the policy will be effective as long as the MPS entity is in business.

In a MPS model, the commission a MPS entity charges to a participating restaurant for generating sales and delivering orders can be the same as or no higher than the commission a bona fide entity in the conventional meal delivery industry would charge. Also, in a MPS model, when a buyer purchases a BFP's product thru the MPS entity, the buyer can pay a price no higher than the price he/she pays through a conventional meal delivery service. The price a buyer pays for a BFP's product through a conventional meal delivery service before delivery fees and tips can be the same as the price the buyer pays if the buyer is dining in the store the BFP operates. Similarly, in a MPS model, a buyer can pay for an item from a BFP with a price no higher than the price the buyer pays if the buyer is consuming the same item in the BFP's store without delivery.

When the MPS entity owns its own store and sells its own products through the MPS delivery service, it can sell the product at a price equal to it sells the product in its own store without delivery.

In one embodiment of the present invention, a “No Tip” delivery can be defined as follows. “A delivery service, in which an order is delivered by a delivery person of a delivery entity and the delivery person can only receive (or expect to receive) the wages from the delivery entity for delivering an order even if the order contains only one ordering unit of the least-priced item sold through the delivery entity.” A “No Delivery fee” delivery can defined as: “A delivery service, in which a delivery entity delivers an order for a seller. The delivery entity receives compensation for the service only from the seller of the product, even if the order contains only one ordering unit of the least-priced item sold through the delivery entity. The delivery entity receives no compensation from any other party”. A “No Minimum Order” delivery can be defined as: “A delivery service, in which an order is accepted and delivered even if the order contains only one ordering unit of the least-priced item sold”.

In the “No Minimum Order” embodiment, a server may allow a customer to order an item with “one ordering unit” of the item. A MPS entity or a BFP may further restrict the meaning of “one ordering unit” to meal items.

One feature of the MPS meal delivery is to deliver a meal to a single person to enjoy. A single person can only eat a limited quantity of food for one meal. In one embodiment, the MPS entity can define the term “one ordering unit” of a meal item by relating to the quantity (e.g. the weight, size, or number of calories) that is enough for a normal person with ordinary appetite to eat for one meal. The MPS entity can use the following method to define the term “one ordering unit” of a meal item. The MPS entity can perform a survey. In the survey, the entity determines the quantity (e.g. the weight or the size) that is enough for a normal person to eat for one meal. For example, the survey shows that a 7 inches pizza or an 18 oz meal would be enough for an average person to eat for one meal. The entity then selects a factor. The entity then use the factor times the average quantity to determine “one ordering unit” of a meal item, i.e. a food item or group of food items for purchase. For example, if the entity determines that a normal person with ordinary appetite eats 18 oz of food for a meal and the factor determined is 1.5, the entity can determine that “one ordering unit” of a meal item is 24 ounces. (18×1.5=24). Alternatively, a single ordering unit can be determined based on nutritional guidelines issued by a governmental agency. Therefore, in a no minimum order policy, a server may allow a customer to order a food item with “one ordering unit” of an item. The one ordering unit of a food item preferably weighs at or less than 24 ounces.

A factor is a number that is used to allow margins in determining the quantity of “one ordering unit” of a meal item. The value of the factor is preferably less than 2, i.e. the price of a single ordering unit is preferably less than two times the average price of items offered to a buyer for purchase, but greater than the average price.

In one embodiment, under the “No Minimum Order” policy, a customer's meal order is accepted and delivered even if the order contains only one ordering unit of the least-priced meal item. The quantity or size of the meal item is not too much and not too small for an ordinary consumer “with the ordinary appetite” to eat for one meal.

In another embodiment of the present invention, under the “No Minimum Order” policy, a customer's order to a food provider is accepted and delivered even if the order contains only one ordering unit of an item. The item is not too large and not too small for a customer “with an ordinary appetite” to eat for one meal and the price of the item is at or below the averaged price of such items sold by the food provider through the MPS service.

In one embodiment, the combination of “No Tip” and “No Delivery Fee” may be alternatively defined as follows. When a customer purchases a product or service, the customer is only charged with the listed price of the product or service plus the statutory fees, such as sales tax, that are associated with the purchase, even if the order contains only one ordering unit of the least-priced item sold through the MPS service. If the customer uses a credit card to purchase, the buyer can optionally be charged with a fee associated with the use of credit card because it costs a merchant to accept credit cards. The fee associated with the use of credit card is not charged to the customer if the customer uses cash to purchase. The customer is not required to pay any other expenses such as tips or delivery fees.

In one embodiment of the present invention, if a MPS entity sells and delivers its own food with MPS delivery service and “No Delivery Fee”, the price a customer is required to pay for a product is the same as the price the customer pays if the product is consumed in the MPS entity's own store without delivery. When a customer uses a credit card to purchase a product, a fee associated with the use of the credit card can be charged as discussed before, but not for the delivery of the product.

The “No Tip, No Delivery Fee, and No Minimum Order” policy can be used by other business opportunities such as grocery deliveries.

One of skill in the art will appreciate that establishing a de minimus minimum order to circumvent the claims of the present invention may be deemed to be within the spirit of the present invention and is deemed to be covered by the invention. For example, if a company sets a minimum order of $1.00 when the lowest-priced item sold by the company is $5.00 a unit. Another example of such a de minimus minimum order is placing a low-price item unrelated to the seller's business on a seller's menu without bona fide business intention to sell the item. For example, in the case of a restaurant placing a five cent straw for sale on its menu, and setting a minimum order above five cents (e.g. at ten cents). In addition, charging a delivery fee to a buyer and at the same time reducing the selling price of the item purchased by the buyer as a way to reimburse the buyer for the delivery fee charged can be deemed as having no delivery fee charged.

II) In another embodiment, a MPS entity may use the following system to speed up the process of picking up orders:

A MPS may contain many racks, which can be movable. In the beginning of an order collecting process, the MPS entity can leave an empty rack to a BFP and a BFP employee can load orders to the empty rack after the orders are completed. When a MPS staff member picks up orders from the BFP, the MPS staff can push away the loaded rack and leave another empty rack for the BFP to fill next time. A MPS entity may design a movable rack in a dimension that is conformed to the dimension of a delivering truck. Or, the MPS entity may design a truck with a dimension that is conformed to the dimension of a movable rack. These designs will allow racks to fit into a delivery truck.

Each rack can be identified by a rack number. Each rack may be divided into cells (or compartments). Each cell may be identified by a cell address (or cell number). A cell address may be defined by the rack number, column number and the row number of the cell. Each cell may be installed with a temperature-controlling device to store food products. A sticker can be attached to the outside, e.g. the rim, of a cell. The sticker contains a bar code (the first bar code) which contains the cell number that identifies the cell. When a BFP packs a buyer's order, the BFP attaches a shipping label to the outside of the order package. The label contains a second bar code. The second bar code contains buyer information and necessary information to identify the buyer's order. Examples of buyer information may be: the buyer's name, telephone number, address, product information, pickup location information, the license plate number of the car the buyer drives, the description of the car the buyer drives, etc. A MPS operator, or a BFP employee, is equipped with a device, preferably a portable device (such as a hand-held device) with a scanner. When a person (e.g. a MPS operator, or a BFP employee) loads an order into a cell, he/she can use the device to scan the first bar code attached to the cell and then scan the second bar code on the shipping label. The scanned information is then stored in the scanner. A microprocessor in the operator's device then relates the information contained in the first bar code to the information in the second bar code. One of skill in the art will appreciate that other electronic labeling technologies, such as those using RFID chips or other wireless technologies, can be used in place of barcoding. The person who loads orders to a rack can be a BFP employee and not a MPS truck operator. In this case, the BFP employee can use his/her scanner to scan the bar code on a rack and the bar code on an order and transmit the scanned information to the operator's scanner.

When a buyer arrives at the pickup point, he/she may identify him/her self to the MPS operator with information such as name, address or telephone number, etc. The operator can key in this information to the device. The device then relays the buyer information to cell address information and locates the cell that contains the buyer's order. The hand-held device can then display the cell address of the buyer's order to the operator. The operator can then retrieve the order according to the cell address and hands the order over to the buyer.

Because a person usually drives the same car every day, a buyer can be identified by his/her car information. Such car information may be the license plate number of the car the buyer drives. The car information can include a description of the car the buyer drives, such as the make of the car and the color of the car, e.g. for purposes of verifying the license plate number information. When a buyer approaches the pickup location, the MPS operator catches the buyer's car information and can enter the buyer's car information, e.g. the license plate number, into the operator's device. The device can use the information, e.g. the car's license plate number, and relate it to the cell address of the buyer's order. The MPS operator can thus locate the buyer's order. A lamp or a similar device can be installed on the outside wall of every cell. When the device locates a buyer's order, the device sends a signal. The signal contains the cell address information of the buyer's order. A controller can be installed in the truck. The controller receives the RF signal with the information. The controller uses this information to locate the cell that contains the buyer's order. The controller then turns on the lamp on the cell. The lamp can blink so that the operator can easily spot the buyer's order.

A buyer's order may contain different items. Each item may be loaded into different cell. To facilitate this, the BFP who produces the order can attach each item with a shipping label that contains the same buyer information. When a person (e.g. a MPS truck operator) loads an item into a cell, he/she can use the device to scan the bar code attached to the cell and then scan the bar code on the shipping label attached to the item until all items are scanned and loaded. A microprocessor in the device then relates the information contained in the first bar code to the information in the second bar code. The device can display to the operator all cell addresses with the same buyer information. Therefore, when a buyer's order contains items that are stored in different cells, the device can display to the operator all the cell address of the cells that contain the buyer's order. If lamps are installed on the outside wall of cells, the controller identifies all cells that contain the buyer's order. The controller then turns on all lamps on the cells on the rack that contain buyer order. The lamps can blink when the order is located. In this way, the operator can easily spot the buyer's order and collect all the items in the buyer's order very easily.

A rack may contain a set of lamps with different colors. For example, a rack may contain a red lamp, a green lamp, a yellow lamp, etc. When a buyer comes to a MPS station, the MPS operator enters the buyer's information to the device, the device sends a signal to the controller. The controller receives the signal and selects a lamp color, e.g. red color, and blinks all the red lamps on the cells that contain the buyer order. When a second buyer comes to the pickup station, the MPS operator enters the second buyer's information to the device, the device can send another signal to the controller. The controller receives the signal and selects a different lamp color, e.g. green color, and blinks all the green lamps on the cells that contain the second buyer's order. In this way, the operator may separately identify the first buyer's order from the second buyer's order. This method can minimize confusion when an operator is processing more than one buyer's order at the same time.

A cell in a rack can be large enough to contain more than one item. Such a cell may be installed with more than one lamp or more than one set of lamps. The controller may activate the number of lamps on a cell to blink according to the number of items in the cell needed to fill an order. For example, assuming there are five roast beef sandwiches stored in cell B. Order A needs two roast beef sandwiches. The controller may blink two lamps on the wall of cell B so that the MPS operator can see the lamps and pick up two roast beef sandwiches from cell B to fill order A. A LED, or a similar displaying device capable of displaying numbers, can be used to display the number of items needed to fill an order. After the operator collects the buyer's order from a cell, he/she may reset the lamps.

The MPS entity may design a decal. The decal can have a number and the number is registered with the entity. The decal can be placed on a driver's dashboard. A MPS operator can see the decal and identify the driver as a MPS customer. The MPS entity can use the decal to replace a license plate to identify a buyer's order. That is, a MPS operator can see the number on the decal, key in the number to his/her hand-held device, and the device can identify a buyer's order. The decal may contain a bar code. The bar code contains the buyer's information. A MPS operator may scan the bar code and the scanner may use the information to identify the buyer's order.

The advantage of using the user's car license plate number to identify the cell address of an order is: the MPS operator can read the license plate number of a buyer's car from a distance. The MPS operator can start to process a buyer's order when a buyer is approaching the pick up point. There is no need to communicate with the buyer face to face in order to identify the buyer. A license plate normally contains a number of letters and numbers. The server may choose to use some of the letters or numbers on a buyer's license plate to identify the buyer.

III) In another embodiment of the present invention, a MPS entity can request a BFP to provide the nutrition information of the foods the BFP produce. The nutrition information may include the calorie count, fat count, cholesterol count, sodium count, etc. of a meal. The nutrition information can be displayed with the food the BFP produces.

The MPS entity can collect a buyer's ordering history and use this information together with the nutritional information provided by the BFPs to monitor a customer's nutritional intake, such as total calories, that the customer has consumed in the food purchased over a period of time. The entity may do so by compiling a total of the nutritional amounts in the foods the customer has ordered for the period of time. For example, if the entity wants to know the total calories the customer has consumed within the last twenty days, the entity may collect the foods the buyer has purchased for the last twenty days and calculate the total calorie counts for each food the buyer has purchased for that period. If within the last twenty days, there are days the buyer did not purchase food from the BFP, an estimate may be used to approximate the total calories the buyer has consumed for the days the buyer did not order from the BFP. For example, an average of the nutrition count for the days the buyer has ordered with the BFP can be used to come up with an estimate for the days the buyer did not order from the BFP. The entity can calculate all nutritional items that are of interest and display the information to a buyer.

The MPS entity may collect a buyer's health information. The health information may include: the buyer's age, gender, blood pressure, cholesterol level, blood sugar level, triglycerides level, etc. The MPS entity may use a buyer's health information along with the buyer's food ordering history to recommend a diet plan to the buyer. The entity may come up with a list of recommended foods for the buyer to purchase. This recommended list of foods can further be screened by the preference information provided by the buyer. For example, if a buyer has consumed too much fat and the buyer favors Chinese food, the server may recommend a Chinese dish with less fat to the buyer. The food items the entity recommended in a buyer's diet plan would preferably be selected from among the food items sold by a BFP associated with the MPS entity. If the buyer wants the MPS entity to use the Automatic Selection Method (ASM) to order food for him/her, the total nutritional value of an item can be a factor to determine the buyer's menu. For example, when using the ASM method to design a meal plan for a customer, the MPS entity can select these dishes in a way that the total calorie counts of the dishes in the plan are limited to a pre-determined amount.

When the buyer does not want to use the ASM method to order and prefers to order food manually, the MPS server can use the buyer's health information and/or the buyer's food ordering history to advise the buyer if the meal the buyer is ordering is unhealthy or is healthy for the buyer. For example, if the buyer's triglycerides reading is 1300. The buyer orders a regular coke to go along with his/her dinner. The MPS server may decide that the sugar content in the coke is unhealthy to the buyer considering the buyer's high triglycerides reading. The entity may, at the time of receiving the order, advise the buyer that a coke is unhealthy to him/her. The MPS entity may do so by issue a warning. A warning may be in different levels. For example, a red warning may be very unhealthy, an orange warning may be unhealthy, a yellow earning may mean neutral, and a green warning may mean healthy.

The MPS entity can post a warning sign with warning level to an item sold on its web site. A warning level for an item sold is determined according to a buyer's personal health information and/or the buyer's ordering history. A warning level for an item may be different for different buyers. For example, a cheeseburger may be posted with red warning sign for buyer A but is posted with green sign for buyer B. As an example, by reviewing a buyer's health information, the MPS entity determines that the buyer's cholesterol level is very high, the MPS entity may post a red warning on the side of a cheeseburger, and post a green warning on the side of a green salad on the menu sent to the buyer. In this way, a buyer receives a menu with warning system that is tailored to his/her personal health condition. The MPS server may hire a health care professional to administer such warnings.

IV) In one embodiment, a piece of LAM (Liquid Absorbing Material) is placed in a meal package.

A MPS truck may be equipped with a temperature control device. An example of such a device is a heating device (e.g. a heater proofer). A customer's order, e.g. Sea Food Pasta, may be kept in the device to be kept warm. However, in this setting, moisture evaporates from the surface of the food over time and the food becomes dry. A method to prevent moisture evaporation and dryness of the food is as follows: When a food item is stored in a container, moisture evaporates through its surface and goes to the container space. If the container is stored in a heated condition, e.g. over 135 degrees Fahrenheit, more moisture evaporates from the food surface and goes to the container space. Some of the moisture in the container space comes back to the food item as a natural process. At the beginning of the process, the quantity of moisture that goes out of the food surface and goes into the container space is more than the quantity of moisture coming back from the container space to the food surface. The process continues. Eventually, the amount of moisture that goes out of the food surface and goes into the container space equals the amount of moisture coming back to the food surface. At this stage, equilibrium is reached.

The evaporation of moisture from the food surface into the container space causes the food item to dry out. In addition, the imperfection of the container sealing or a leakage in the container body causes more moisture to evaporate from the food. To prevent the effect of moisture loss on the food surface, a piece of Liquid Absorbing Material (LAM) can be placed in the container. The LAM, acting as a sponge, is preferably made of food-graded material and is preferably transparent. The LAM is soaked with liquid, e.g. water, before sealed into the container. The LAM is preferably placed on top of the food to cover the food. As an alternative, the LAM may be installed on the inside wall of the container and is pre-soaked with liquid before the food item is put into the container. The LAM supplies moisture to the container space and causes equilibrium to be reached with less moisture coming from the food surface. This process reduces the dryness of the food. This device may be used to improve the quality of the food during storage. The container is sealed after the food item is put inside it. The surface of the container may have one or more holes of selected size to release container pressure due to heating of the container and maintain proper moisture inside the container.

A container that stores food may be installed with a piece of LAM inside it. When a consumer heats up the container with a microwave oven, the moisture coming out of the LAM can act as a steamer. The process can heat up the food item and at the same time keep the food moist.

V) In one embodiment, a pickup location is selected based on the parking availability of the pickup location and the package volume of the buyer's order. Because pick up locations may have different parking capabilities, some pick up location (such as a gas station) may have a limited amount of parking spaces, and some pick up location (such as a shopping center) may have a larger amount of parking spaces. In this embodiment, the MPS entity sets up a rule for selecting pickup location for a buyer to use. In the rule, the MPS entity selects a pick up location for a buyer to use based on the available parking spaces of the pick up location and the package volume of the buyer's order. The rule can be as follows. When a buyer completes his/her order, the MPS entity can determine the number of packages in the buyer's order or the package volume of the buyer's order. If the number of packages the buyer's order contains is over a determined amount, e.g. 3 individual meal packages, the buyer is directed to use a pick up location with parking spaces fewer than a determined number (e.g. less than 20 available parking spaces). Similarly, if the package volume of the buyer's order is over a determined amount, e.g. 2 cubic feet, the buyer is directed to use a pick up location with parking spaces fewer than a determined number (e.g. less than 20 available parking spaces). The reason for such an arrangement is as follows: Since the carrying capacity of a pickup location is fixed, assigning more buyers with larger number of orders to use a pickup location would result lesser buyers coming to the pickup location to pick up orders. The method can reduce the traffic condition in a pickup location where parking space is limited.

Because traffic condition is less of an issue with a pick up location with a large number of parking spaces, it is therefore logical to assign buyers with lesser packages to such a pick up location.

The MPS entity can ask the owner of a pick up location to provide parking space availability information. The MPS entity can use this information to group pick up locations into groups. The grouping of pickup locations can be based on the number of parking spaces in a pickup location. For example, a pick up location with fewer than 20 parking spaces may be classified as group one. A pick up location with parking spaces between 20 and 50 may be classified as group two. A pickup location with over 50 parking spaces may be classified as group three, etc. When a buyer completes his/her order, the seller or the MPS entity can calculate the total number of packages, or the total package volume, of the buyer's order. The MPS entity then groups buyers into groups according to the number of packages in a buyer's order or the package volume of a buyer's order. The MPS entity then uses the parking space grouping information and the packaging number grouping information to release a pickup location to a buyer. For example, a buyer who picks up an order with over three packages may be directed to use a pick up location in group one. A buyer who picks up an order with two or three packages may be directed to pick up his/her order at a pick up location in group two. A buyer who picks up an order with only one package may be directed to pick up his/her order in group three.

In case the MPS entity allows a buyer to select the buyer's desired pickup location to use, the MPS server may display to the buyer the pickup locations that satisfy the above selection rules. The MPS server can hide the pick up points determined not satisfying the selection rules from the buyer so that the buyer may not have the opportunity to select these pick up points.

Many times, the purchase price of an order is in relationship to the quantity of products a buyer purchases. The server may use the dollar amount (the purchase price) of the order as a guide to assign pick up points. In this case, an order with a larger dollar amount may be assumed to contain a larger quantity of products or with a larger package volume. The order is thus assigned to a pick up location with fewer available parking spaces. By the same token, an order with a smaller dollar amount may be assumed to contain a smaller quantity of orders or a smaller package volume. The order is thus assigned to a pick up point with more available parking spaces.

Generally speaking, the size of the premises of a pickup location has a positive correlation with its parking availability. For example, a four-acre shopping center would have more parking spaces than a three-acre shopping center. Therefore, a MPS entity may use the size of the premises of a pickup location as a base to estimate the parking availability of the pickup location and use it as a parameter to select pickup location.

VI). In one embodiment, the MPS server can use a buyer's physical address, e.g. home address and/or office address, to project (or to identity) a segment of the user's travel route and uses this information to select pick up points. In one embodiment, the MPS server uses a buyer's home address, or office address, or both, to project the pickup location, e.g. a gas station or a shopping center, the buyer most likely to pass when the buyer commutes. The MPS server can project the pickup location as a pickup location that is very convenient for the buyer to use. The MPS server can project the pickup location as the buyer's preferred pickup location and delivers the buyer's order to the pickup location waiting for the buyer to pick up the order.

In one option of the embodiment, the server uses the buyer's physical address (e.g. home address or office address) as a reference point to search for (and/or to display) the highways or major streets around the address. Once the highways/major streets are identified, the server may display the pre-arranged pick up locations along these highways or streets for selection. A pre-arranged pickup location can be a gas station or a shopping center. The MPS entity may display these pickup locations for the buyer to select. The entity may select a pickup location among these pickup locations and assign the pickup location for the buyer to use.

Refer to FIG. 14 as an example, H 3275 is the buyer's home. The server can use the buyer's home address H 3275 to identify the highway (s) around the buyer's home. In the example, Highway 10 3210 and Highway 60 (not shown) are highways around the buyer's home. The MPS entity can first calculate the distance of each exit on Highway 10 or Highway 60 to the buyer's home. Using the information, the MPS server may select a determined number and finds the determined number of exits on a highway that are closest to the buyer's home. For example, the server may select two exits, M 3232 and N 3242, on Highway 10 that are closest to the buyer's home H 3275. Because route MRH connects M 3232 to the buyer's home H 3275, the server can assume that the buyer may travel through route MRH when the buyer commutes and can release a pickup point, e.g. P 3236, along MRH to the buyer for the buyer's use. In the example, HWY 10 can be a major street and M3232 can be an intersection of the major street with another street. A route segment such as MRH that connects a highway exit or a major street intersection to a buyer's home is termed “Exiting Segment”. There may be many routes that connect a highway exit and a buyer's home. In this embodiment, the MPS entity searches and identifies a highway or a major street around the buyer's physical address and find the shortest Exiting Segment (the Preferred Exiting Segment). The MPS entity then searches for gas stations, shopping centers, or locations where parking is available for MPS stations to park along the Segment. The MPS entity can then display these pickup locations for the buyer to select. The entity can, among these pickup locations, select a pickup location and assign the pickup location to the buyer to use.

Before a pickup location (e.g. a gas station or a shopping center) is selected, the entity needs to register the address of the pickup location in its database. Once a pickup location is selected, either by the MPS entity or by the buyer, the entity needs to transmit the address of the pickup location and the buyer's order to the producing BFP. The BFP can relate the buyer's order to the pickup location the buyer supposed to arrive at to pick up his/her order. The BFP can use the information to print a packing label. The label will be attached to the order so that a MPS operator can identify the order.

The MPS server may define the meaning of “major street”. For example, a major street may be a street with over a determined amount of traffic within a determined amount of time.

Instead of projecting a buyer's “Preferred Exiting Segment” as described, the MPS server may allow a buyer to identify the exit and the streets the buyer prefers to use when a buyer commutes and use this information to build the buyer's Preferred “Exiting Segment”. Once a buyer's Preferred “Exiting Segment” is determined, the MPS entity can release a pickup location along the Preferred “Exiting Segment” for the buyer to use.

The MPS entity may collect the “Preferred Exiting Segment” for other buyers and overlap these routes to determine an overlapped segment as described before. Pickup points may be selected along the overlapped Preferred “Exiting Segment” with the method discussed previously.

Once a buyer's Preferred “Exiting Segment” is defined, the MPS entity can select a channel width or allow the buyer to select a channel width along the route. The MPS entity can build a channel along the route using the method discussed before. The MPS entity can select a pickup location within the channeled area for the buyer to use.

In one embodiment, the MPS entity may ask a buyer to indicate the direction of traveling when the buyer travels on a highway or a major street. The entity may use this information to project the exit the buyer uses when the buyer travels to his/her travel destination. For example, if the buyer indicates that he/she is traveling on highway X and traveling towards direction Y. If Z is the closest exit on highway X to the customer's destination from among the exits accessible from the direction the customer is traveling. Z can be projected as the exit the buyer uses. For example, if the buyer uses highway 10 and travels eastbound when he/she goes home, the MPS entity may project M 3232 as the exit the buyer uses because it is the closest exit to the buyer's home and is west of the buyer's home.

Instead of projecting a buyer's preferred exit, the MPS entity may allow the user to select a highway and indicate the highway exit the buyer prefers to use.

Once a buyer's preferred exit is identified, either by projection or the buyer's input, the MPS entity can use it as an parameter to release the pre-arranged gas stations or shopping centers around it for the buyer to use. The MPS entity may determine a distance around an exit. With the exit and the distance, the MPS entity can define an area. The MPS entity can release all pre-arranged gas stations or shopping centers within the area to the buyer to be uses as pickup locations. Or, the MPS entity may allow the buyer to define a distance from the exit. The distance and the exit can define an area. The MPS entity may release all pre-arranged gas stations or shopping centers within the area to the buyer to be used as pickup locations.

In one embodiment, the MPS entity uses the telephone number or the address of the buyer's travel origin (the place the buyer starts to travel, such as the buyer's office) to project the buyer's travel direction when the buyer travels. For example, the server can collect the buyer's office address or telephone number. By knowing the buyer's telephone number or office address, the server can determine the direction of the buyer's office relative to the buyer's home. The server can then project the direction the buyer will travel when the buyer goes home from work.

In one embodiment, the MPS entity can identify the exits on the highways around a buyer's physical address. The MPS server then calculates all Exiting Segments. As discussed, an Exiting Segment connects a highway exit with the buyer's physical address. The MPS server then identifies the shortest Exiting Segment. The exit that connects the buyer's home with the shortest Exiting Segment can be projected as the buyer's preferred exit.

In one embodiment, the MPS entity can release the pickup locations that locate in the area between a buyer's preferred exit and the buyer's home to the buyer to use. The area between the preferred exit and the buyer's home may be defined as follows: The MPS entity connects the buyer's preferred exit and the buyer's home with a straight line. The MPS entity can draw a line that is vertical to the straight line from the preferred exit. The MPS entity can draw another line from the buyer's home that is also vertical to the straight line. The space between the two lines can be defined as “the area in between the exit and the buyer's home”. For example, in FIG. 14, assuming M 3232 is the buyer's preferred exit and H 3275 is the buyer's home. The MPS entity draws a line MH that connects M 3232 and H 3275. The MPS entity then draws a line at M 3232 that is vertical to line MH. The MPS entity draws another line at H 3275 that is also vertical to line MH. The pickup locations that are between these two lines can be displayed for buyer to use. Further, the MPS entity can select a distance or let a buyer to select a distance from the straight line, e.g. MH, and build a channel along the straight line. The channel defines an area and the MPS entity can display pickup locations within this area for buyer to use. In the embodiment, H 3275 may be the buyer's office and M 3232 may be the preferred exit the buyer uses when the buyer goes to/from work. The MPS entity may then select a pickup location between buyer's office and the preferred exit for the buyer to use.

Each embodiment can be used in combination with zip code, telephone number, city name or landmark in identifying pick up points. An identifier, such as a zip code, a telephone number, or a city name, can define and cover an area. When such an identifier is used for pickup location selections, the MPS entity may identify the highways covered by the identifier. The server can select a highway within the identifier that is the closet to a buyer's home or office. The server can identify the exit on the highway that is the closest to the buyer's home or office. The server also can identify the driving route that connects the exit and the buyer's home or office. The server may project the driving route as the route most likely to be used by the buyer and place pickup locations along the route for the buyer to use. A gas station or a shopping center parking lot that is along the route may be a good candidate for pickup point selection. As an option, the server can simply identify the exits on the highway that are the closest to the buyer's home or office and identify the off-ramp street that connect to the exit. The server may project the off-ramp street as the route most likely to be used by the buyer. The server can place pickup locations along the off-ramp street. A gas station or a shopping center parking lot that is along an off-ramp street may be a good candidate for pickup point selection. Once the server can project the route most likely to be used by the buyer, the server can select a pickup location along the route for the buyer to use.

VII) A buyer may be associated with a group. The members of the group use the MPS service to purchase. Each member in the group has his/her own preferred pickup location. Each member may order different meal from different BFPs but each member shares a common physical address, e.g. a home address or an office address. In one embodiment of the present invention, an arrangement can be made so that one member of the group may pick up the orders of all members of the group at the pick up point preferred by the member who picks up the orders. In the embodiment, every member in a group is identified by a group code. The group code may be the street number of the group or may be another type of identification. When a user registers with the server, the user may be provided with a template to enter his/her information. Assuming A is a user belongs to group G. In the template provided by the MPS server, a space may be used by user A to enter his/her group code. All members in the group are identified by the same group code. When a user, e.g. user A, places an order, user A selects his/her own preferred pickup point as previously described. So do all other members in the group. User A, may select his/her preferred pick up point which may be different from the pick up point selected by any other members of the group. A box called “pick up member” is provided to all group members in a server provided template. When a member, such as member A, is scheduled to pick up orders for all the members in the group, the member checks the “pick up member” box. The MPS server then searches for all buyers with the same group code and temporarily changes the pickup location of all members in the group to the pick up location of the pick up member. In this way, all orders in the group will be delivered to the pick up location selected by the pick up member. The MPS entity also temporarily changes the order recipient of all members in the group to be the “pickup member” so that when the “pickup member” arrives at the pick up point, the member is authorized to pick up all the orders of the group.

Each member may select a date or dates to be the pickup member. For example, in a group, member John may select every Monday and Tuesday as the pickup member and member Peter may select every Wednesday and Thursday as the pick up member. The MPS entity then arranges to deliver all the group members' orders to the pick up point selected by John on every Monday and Tuesday. The MPS entity arranges to deliver all the group members' orders to the pick up point selected by Peter on every Wednesday and Thursday. Also, the MPS entity may update its contact information so that the MPS entity may call or send an email to the pick up member for picking up of the orders.

VIII) A MPS entity can save more delivery costs if it can arrange for its buyers to use fewer pickup locations. The fewer pickup locations buyers use, the lower the delivery costs will be for the MPS. For example, if a MPS entity has 400 customers, the entity will incur less operating costs if it can arrange its customers to use three pickup locations instead of using five pickup locations.

In this embodiment, the MPS entity regulates the selection of pickup locations to save delivery costs. For example, pickup location A and pickup location B are along Grand Avenue and are one block away from each other. The two pickup locations are so close to each other that opening both pickup points at the same time for buyers to use would be unnecessary. Since these two pickup locations are not far away, a better approach is to release only one of the two pick up points for the buyer to use in the first stage. When the released pickup point reaches its full capacity of orders, the server then releases the other pickup point for buyer to use.

In one embodiment of the present invention, the MPS entity uses this concept to cut delivery costs. In this embodiment, a MPS entity pre-arranged a number of pickup locations and groups the pickup locations into groups. A limited number of pickup locations (preferably one or two) in a group is released at a time for buyers to use while other pickup locations remain closed to buyers until the volume of orders exceeds the capacity of the pickup locations already released for use. A released pickup location is closed when its carrying capacity is full. At that time, another pickup location in the group is released for buyers to use. A buyer cannot select a pick up location that is not released. In the embodiment, pickup locations are grouped into groups. The entity may select a limited number of pickup locations, e.g. one, in the group to release for buyers to use and hide the others. A buyer is then forced to use the pickup location(s) released. The MPS entity can monitor an opened pickup location and calculate how many orders are scheduled to be picked up at that location. Once the opened pickup location has accumulated enough orders to reach its carrying capacity, the pickup location is closed for selection. Another pickup location in the group can be released for buyers to use. In this embodiment, a MPS entity first selects one pick up location (or a limited number of pickup locations) in one group for buyers to use. All buyers are forced to use the same opened pickup location until the number of orders scheduled at that location reaches the MPS's carrying capacity.

The MPS entity can first determine the criteria of grouping pickup locations. A locality of pickup locations can be used to group the pickup locations. For example, pickup locations in the same area, e.g. with the same zip code, or on the same street, or in the same town, can be grouped together. Or, the MPS entity can use the proximity of two pickup locations as a criterion for grouping. The MPS entity may define the meaning of proximity. For example, if the MPS entity determines that the distance between two pickup locations is within ¼ mile satisfies the meaning of proximity, and any two pickup locations within ¼ mile of each other can be grouped together.

The MPS entity may divide an area (e.g. a city) into a grid, and group the pickup locations within a square on the grid as a group. The MPS entity may select a reference point and group all pickup locations within a certain distance (e.g. ¼ mile) from the selected reference point. Alternatively, pickup locations that are equally convenient to buyers may be grouped together. For example, pick up locations that are located along a busy street may be grouped in one group. Pickup locations that are within a certain distance from a landmark that many people gather can be grouped in a group. A landmark can be a highway exit. For example, pickup locations that are located within a certain distance, e.g. 2 miles, from a highway exit can be grouped together.

A MPS entity can set up a priority system for the releasing of pickup locations in a group. A pickup point with a higher priority rating in a group is released to buyers prior to a pickup point with a lower priority rating in the same group. There are many ways to determine the releasing priority of a pickup point. One way of prioritizing a pickup point is to use the projected usage of that pickup point. A pickup point in a group that is projected to be used more often by buyers can be assigned a higher priority rating than a pickup point that is projected to be used less often by buyers. Therefore, a pickup point that is located by a major street with busy traffic can be assigned a higher priority rating than a pickup point that located by a small street with less traffic. Similarly, a pickup point that is along a route segment that is overlapped by more buyer travel routes can be assigned a higher priority rating than a pickup point that is along a route segment that is overlapped by less buyer travel routes. For example, a pickup point that is along a route segment that is overlapped by fifty buyer travel routes can be assigned a higher priority than a pickup point that is along a route segment that is overlapped by five buyer travel routes. In the embodiment, the MPS server collects the traffic condition of a road or a street near a pickup point. The MPS server may also collect the concentration of buyer preferred travel routes near the pickup point. The priority rating of a pickup point can be determined by the traffic condition of a nearby road or street. It can also be determined by the buyer travel route concentration near the pickup point. A pickup point with higher priority rating is displayed for buyer to use before a pickup point with lower priority rating. The MPS server may determine a threshold for a pickup point usage. Once the threshold is reached, a pickup point with lower priority is released for buyer to use. A threshold may be determined based on the carrying capacity of a pickup point. For example, if the threshold of a pickup point is for it to be using 90% of its carrying capacity, then, if the orders assigned to the pickup point reach 90% of its carrying capacity, a pickup point with lower priority is opened. If the threshold of a pickup point is for it to be using 100% of its carrying capacity, a pickup point with lower priority can only be released for use when the pickup point of a higher priority reaches its carrying capacity. In this embodiment, the sequence of displaying a pickup point in an area is determined by the priority rating of the pickup point. The priority rating of a pickup point can be determined by the traffic condition of a nearby road or street. As an alternative, the priority rating of a pickup point can be determined by the concentration of buyer preferred travel routes near the pickup point.

IX). The MPS entity may find it more cost efficient to collect orders from a BFP if the BFP is located close to other BFPs. This is because when the MPS entity picks up orders from the BFP, it can pick up orders from other BFPs at the same time to save transportation costs.

In one embodiment, the MPS entity groups BFPs that are close to each other in a group. Consider the following example: Assume store A1 3250 and store A2 3254 (see FIG. 14) belong to the same franchise chain A (BFP A), and store B1 3252 and store B2 3256 belong to franchise chain B (BFP B). Also assume A2 3254 and B2 3256 are located in one location or are close to each other. A1 3250 and B1 3252 are some distance apart from each other. Assuming when the MPS entity accounts for all orders, it discovers that both BFP A and BFP B receive orders. Assume further that none of these orders are large enough for the MPS server to justify the cost of sending one MPS station to either A1 3250 or B1 3252 in a separate trip to pick up orders. The MPS server may ask BFP A and BFP B to pass the production of their orders to store A2 3254 and store B2 3256. In this way, orders of BFP A are produced by A2 3254 and orders of BFP B are produced by B2 3256. Since A2 3254 and B2 3256 are in one location (or are close to each other), the MPS server may pickup all the orders in one trip. Here, because A1 and A2 (or B1 and B2) belong to the same chain, they should have no problem producing the same product.

A BFP that is grouped with other BFPs may receive higher priority in receiving orders than a BFP that is not grouped with other BFPs. For example: assume store A2 3254 receives a higher priority in receiving orders than store A1 3250 and store B2 3256 receives higher priority in receiving orders than store B1 3252. An order for chain A is passed to A2 3254 before it is passed to A1 3250. An order for chain B is passed to B2 3256 before it is passed to B1 3252. Assume chain A received 300 orders for Seafood Pasta. The order is passed to A2 3254 for production first. If the total production capacity of A2 3254 is 250 meals, the balance of the order (50 meals of Seafood Pasta) is then passed to A1 3250 for production. In other words, an order is passed to a store with higher priority first. The order is passed to a store with lower priority if the store with higher priority does not have the capacity to produce the order.

The MPS entity first determines the criteria of grouping BFPs. The criteria of grouping BFPs is the same as grouping pickup locations as described before.

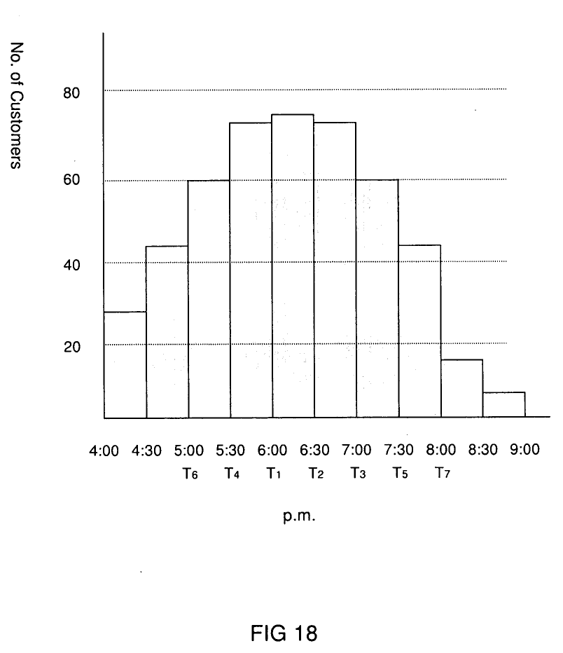

X) In one embodiment, the MPS entity determines the time a MPS stations at a pickup location based on the time its potential or current customers pass by or arrive at the pickup location. Also, the MPS entity determines the time a MPS stations at a pickup location based on the time its potential or current customers are most likely to pass by or most likely to arrive at the pickup location. The number of potential customers or customers that pass by or arrive (or most likely to pass by or arrive) at a pickup location may form a pattern or a distribution over a period of time. For example, potential customers start to pass by a pickup location at 4:00 p.m., the number of pass-bys gradually increases, reaches its peak between 6:00 p.m. to 6:30 p.m. then gradually reduces, and approaches zero after 9:00 p.m. FIG. 18 is an example of such a distribution. In FIG. 18, the height of a bar represents the number of potential customers who pass by a pickup location within a period of time. For example, the figure shows 60 potential customers passing by the pickup location between 5:00 p.m. to 5:30 p.m. The distribution of potential customers passing by a pickup location over time is called a “Customer Pass-by Distribution” (CPD). In one embodiment, the MPS entity uses the Customer Pass-by Distribution at a pickup location to project the distribution of its customers arriving at the pickup location. The distribution of customers that arrive at a pickup location during the customers' commute to and from work is called a “Customer Arrival Distribution” (CAD). The MPS entity can use the projected Customer Arrival Distribution at a pickup location to determine the start of the Station Time and/or the end of the Station Time of a MPS station at the pickup location. The Customer Pass-by Distribution at a pickup location can be determined by estimation or by inquiries. The traffic flow distribution of a near-by major street or a highway may be used to estimate the Customer Pass-by Distribution of the pickup location. Inquiries sent out to potential customers asking the times that they pass by a pickup location can be used to determine the Customer Pass-by Distribution of the pickup location.

In one embodiment, the MPS entity can determine the Station Time of a MPS station at a pickup location based on the Customer Pass-by Distribution at the pickup location along with the costs and benefits associated with stationing a MPS at the pickup location for the period of time. In the embodiment, the MPS entity can use Customer Pass-by Distribution at a pickup location to project the Customer Arrival Distribution at the pickup location. Based on this information, the MPS server may determine the orders to be picked up at the pickup location for a particular period of time. The MPS entity can then perform a cost-and-benefit analysis of stationing a MPS station at the pickup location for the period of time. If the costs of stationing a MPS station at the pickup location for the period of time exceed the revenue received at the pickup location for the period of time, the period of time is excluded as Station Time at the pickup location. A MPS entity can use the method to determine the start and/or the end of the Station Time of a pickup location.

For example, the MPS entity may determine (or estimate) that six or less customers would come to a pickup location between 8:30 p.m. to 9:00 p.m. and the costs of stationing a MPS station between that time at the pickup location is $30.00. The MPS entity would not station a MPS station between 8:30 p.m. to 9:00 p.m. at the pickup location if the income generated from the six customers is less than $30.00. In this case, the Station Time at the pickup location would end at 8:30 p.m.

In one embodiment, a MPS entity uses Customer Arrival Distribution and the methods disclosed above to determine the Station Time, the start of Station Time, and the end of Station Time of a pickup location. Customer Arrival Distribution may be obtained by analyzing the commuting information of the MPS entity's customers. The MPS entity may collect a customer's commuting information when the customer registers with the MPS service. As an example, after customers register to the MPS service, the MPS entity observes that the first customer arrives at a pickup location at 3:15 p.m. and the last customer arrives at the pickup location at 8:45 p.m. The MPS entity may set the Station Time at the pickup location from 3:15 p.m. to 8:45 p.m. Because the MPS entity determines (or estimates) that no customer will arrive at the pickup location before 3:15 p.m., the MPS entity may not want to start its Station Time at the pick up location before that time.

If a MPS entity has many pickup locations, the entity may set one Station Time uniformly for all pickup locations. A uniform Station Time may be determined by using various averages from relevant data. Examples of information on averages may be the average carrying capacity of all MPS stations, the average Customer Pass-by Distribution or the average Customer Arrival Distribution at all pickup locations or the average station costs of MPS stations at all pickup locations.

Once the Station Time at a pickup location is determined, it is published to all customers. In the beginning of a MPS operation, a MPS entity may only have a small number of customers but the MPS entity projects that it will receive a large number of customers later, for example, three years from now. In this case, the current Customer Pass-by Distribution of a pickup location may be different from the Customer Pass-by Distribution of the pickup location at the later time. Consequently, the current Station Time at a pickup location may be different from the Station Time at the pickup location at a later time. However, the MPS entity may decide that it is beneficial to keep the Station Time at a pickup location the same over time, even if the Customer Pass-by Distribution or the Customer Arrival Distribution increases or decreases over time, because changing the Station Time at a pickup location may create confusion and can be costly. Therefore, a MPS entity may determine the Station Time for a pickup location based on projected future Customer Pass-by Distribution (or Customer Arrival Distribution), even if the Station Time does not justify the costs incurred and benefits received currently.

XI) A MPS entity needs efficiency in picking up orders from these producing restaurants (BFPs). This is because a MPS truck may need to pick up orders from multiple places and there is a limited window of time each day when a MPS truck can travel to different restaurants (BFPs) to pick up orders. This is because the time between the pickup of orders at the first restaurant and the final delivery must be minimized. In one embodiment, the MPS entity uses the following method to group BFPs to increase pickup efficiency. In this method, the MPS entity groups BFPs into groups and assigns orders to or accepts proposals from the BPF groups one group at a time. The MPS entity first determines the criteria for grouping BFPs. The MPS entity can use the proximity of BFPs to each other as a criteria for grouping BFPs, for example. In this case, the MPS entity determines the meaning of proximity. Proximity may be defined by a distance, e.g. within ¼ mile. In this case, a group of BFPs that are located within ¼ mile of each other or with respect to a particular location are grouped together. In another example, the MPS entity may select a reference point and group all BFPs within a certain distance (e.g. ¼ mile) from the selected reference point. A reference point can be a landmark or a pickup point. Alternatively, BFPs that are equally convenient to the MPS entity to pickup orders may be grouped together. For example, BFPs that are located in a shopping center or located within a determined number of blocks may be grouped in one group. It is very common to see different restaurants clustered in one location, as in a food court at a shopping center. If a cluster of restaurants, for example, containing an American restaurant, a Japanese restaurant, a French restaurant and a Chinese restaurant, is within the pickup distance of a MPS central kitchen, the MPS staff can then select American food, Japanese food and French food in a meal plan and have no problem picking up these orders. If a Mexican restaurant is too far away from the cluster, the MPS staff will not select Mexican food in the meal plan at the same time if the travel time between the cluster and the Mexican restaurant is too long and/or if the additional transportation costs are too high.

The MPS can also establish criteria to determine the priority of assigning production to a BFP. One of the criteria is the convenience of reaching a BFP from a MPS warehouse. For example, under this criterion, a BFP that is the nearest to a MPS warehouse is assigned production first. The second nearest BFP to the warehouse is assigned for production when the production capacity of the nearest BFP is full. In this way, the MPS entity can reach the maximum efficiency in picking up orders.

Because it is costly for a MPS entity to pick up an order from a BFP, a MPS entity may find it necessary to establish a “minimum production order” to justify pickup costs. A “minimum production order” is the least number of meals a BFP or other supply has to produce in order for a MPS entity to pick up and justify its costs. A “minimum production order” can be determined by factors such as transportation costs incurred for traveling from a MPS warehouse to a BFP or from one BFP to another BFP, and the revenue the MPS entity receives out of delivering these orders. A “minimum production order” can be expressed in dollar terms. For example, the transportation cost for a truck to travel from a warehouse to a BFP is $24.00 and the MPS entity receives 30% commission from the BFP for the sales it generates for the BFP, the minimum production order can be $60.00 ($24.00/0.30=$60.00). Different BFPs can be subject to different “minimum production orders.” To simplify the process of planning of meal plans, a MPS entity may set up a uniform “minimum production order” for all participating BFPs. An offer from a BFP can be accepted only when the quantity the BFP proposes to produce is at least the minimum production quantity. A uniform minimum production order can be computed as follows. The MPS entity can determine the transportation costs associated with picking up orders from a group of BFPs. The transportation costs can include driver salaries, projected fuel costs, insurance and truck depreciation/leasing costs (which may be, for example, $900 per day). The MPS entity then determines the number of BFPs it plans to recruit for production. For example, 25 BFPs. The uniform minimum production order then is $900/25/30%=$120, where 30% is the commission rate charged to a BFP for an order generated and delivered by the MPS service. For ease of operation, an uniform production order can be applied to a BFP regardless of the actual operation costs incurred at the BFP.

In order for the operation of picking up orders from BFPs more efficient, a MPS entity can determine a production quantity. A BFP can be required to provide a meal in the quantity determined by the MPS entity. This embodiment allows the MPS entity to pick up orders from a BFP more efficiently.

The following is an option of how “production quantity” works. In the embodiment, the MPS entity provides racks to BFPs to store orders produced. The racks are preferably mobile. The MPS entity can leave an empty rack to a BFP and the BFP can load orders to the empty rack after the orders are completed. When the MPS staff picks up orders from the BFP, the MPS staff can push away the loaded rack and leave an empty rack for the BFP. In this way, the loading of a BFP's product onto a MPS truck can be facilitated. A MPS entity can use commercially available racks without the need to design and produce its own racks. A production quantity may be determined by the storage quantity of such a rack. For example, if a commercially available rack that the MPS entity decided to use can house 125 orders, the MPS entity may set the production quantity at 125 order units. The MPS entity then requires a BFP to produce a meal in such a quantity. Here, all individual meals are preferably packaged in a uniform package with uniform dimensions. The advantage of this method is that it would be easier for a MPS entity to pick up orders and there would be no wasted space in a pickup truck.

A production quantity may be determined by the maximum production capacity of a BFP, the carrying capacity of a MPS pickup truck and the number of BFPs the truck can travel to within the limitations of pickup times. Assuming that the carrying capacity of a MPS truck is 450 orders and the maximum production capacity of a BFP is 200 orders, a MPS truck can be arranged to go to three BFPs to pickup orders for better efficiency. This is because if a MPS truck goes to one or two BFPs to pick up orders, a BFP would be forced to produce a quantity of orders that exceeds its production capacity. At the same time, because of the time limitations applied to a MPS truck for picking up orders, a MPS truck may not have time to go to four different BFPs to pickup orders. In this example, three BFPs is the number of BFPs a MPS truck can travel to pick up orders most efficiently. In this case, the production quantity for a BFP may be determined as 150 (450/3=150).

A BFP can be allowed to produce a meal in increments of the predetermined production quantity. That is, a BFP can be allowed to produce a meal in one, two or three predetermined quantity units. For example, if the production quantity is 125 orders, a BFP may be allowed to produce 250 orders for a meal. In this case, a BFP needs two racks to house the orders produced. In one embodiment, the MPS can assign each BFP only one meal to produce in a day. In this way, a BFP can enjoy the benefit of batch production and ease of packaging.

The MPS entity can also determine the contents of the meals to be listed for each day in a meal plan. For example, if the MPS entity determines that the number of meals to be listed on July 12^{th} is three, the MPS entity can then determine these three meals in the plan to be, for example, lemon chicken, a sushi plate and seafood pasta. In Embodiment B, after the meals for all the days in the plan are determined, the meal plan is presented to buyers to purchase. The MPS can disclose the providers of the meals in the plan and the regular selling price of the meals. For example, the MPS entity can display in the plan that the lemon chicken meal of July 12^{th} is provided by BFP A with a regular selling price of $8.00. A meal provided by a BFP in a plan is preferably a meal regularly sold by the BFP. The BFP can be asked to provide the regular selling price of a meal when it submits the meal for evaluating, i.e., the selling price offered by the BFP for the meal at a restaurant or other physical location, or offered through a service other than that offered by the MPS entity. If the meal submitted is accepted by the MPS entity, the MPS entity can publish the pricing information of the meal so that a buyer can know how much he/she saves by purchasing the meal through the meal program.

XII) In one embodiment of the present invention, an improved method of displaying pickup locations to a buyer for the buyer's use is presented. The method is:

When MPS entity displays a map to a buyer for pickup location selections, the entity may display a map that covers too large an area with too many pickup locations. This may create inconvenience to a buyer, as displaying a map that covers too large an area to a buyer can cause the area around the buyer's home to become very small and hard to recognize on the buyer's computer screen. The best way to display a map to a buyer is to display only the area the buyer needs and discard the areas that have no use to the buyer.

Many buyers commute using highways. Many of them may prefer to use a pickup location that is located between the exit where the buyer gets off a highway and the place where he/she resides. Therefore, the best map to display to a buyer to select a pickup location is the map that covers only the area between the highway exit the buyer uses and his/her home. In the map, other areas that are of no use to the buyer are not displayed.

The MPS entity may ask a buyer to indicate the highway the buyer uses when the buyer he/she commutes. The entity can then search the exits on the highway and calculate the distance between an exit on the highway to the buyer's home. The MPS entity can identify the exit on the highway that is the shortest distance (e.g. straight line distance or driving distance) to the buyer's home. The MPS entity can use the exit and the buyer's home as reference points and identify the area between the exit and the buyer's home. The MPS entity can display a map that covers that area. The entity can display available pickup locations on the map. In another embodiment, the entity can use the buyer's home address to search and identify the closest highway to the buyer's home. The entity can then assume the highway as the highway the buyer commutes. The entity can then calculate the distance from an exit on the highway to the buyer's home and can identify the exit that is the shortest distance (e.g. straight line distance or driving distance) to the buyer's home. The MPS entity can identify the area between the exit and the buyer's home. The MPS entity displays a map that covers the area with pickup locations. A highway that is the closest to a buyer's home can be defined as: 1). the highway that has the shortest straight line distance between the buyer's home and the highway, or 2). the highway with an exit that has the shortest distance (e.g. straight line distance or driving distance) among all exits of all highways around the buyer's home.

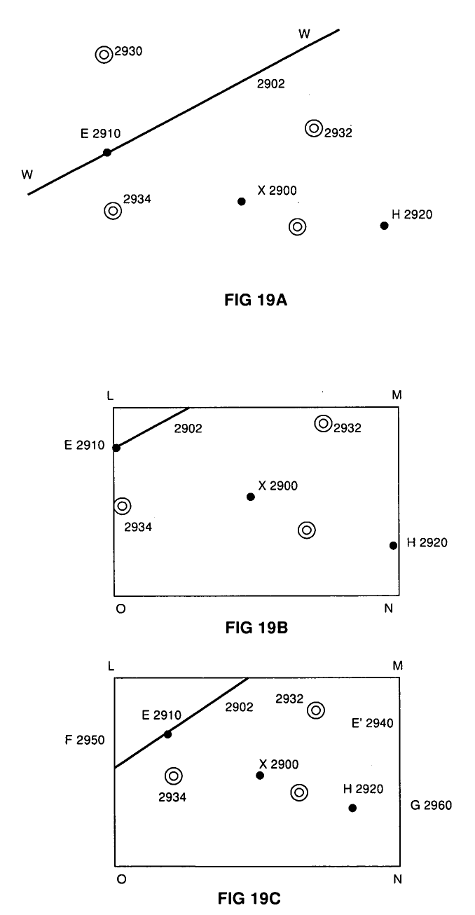

Refer to FIG. 19A. WW 2902 is a highway or major street where the buyer commutes. E 2910 is the exit the buyer uses when he/she gets off the highway. If WW 2902 is a major street, E 2910 is the intersection with a crossing street where the buyer turns onto the crossing street. H 2920 is the buyer's home. Symbols 2930, 2932, 2934 are pickup locations. The entity can use E 2910 (an exit) and H 2920 (the buyer's home) as reference points to display a map. The entity can select a reference point, X 2900, and can use the reference point as center and zooms in and out of the map until E 2910 and/or H 2920 reach the border of the map available to display on the buyer's monitor screen. See FIG. 19B as an example of a zoomed map displayed to the buyer. The entity zooms in and out of the map until E 2910 and/or H 2920 touches LMNO, the board of the map available to be displayed to the buyer on the buyer's monitor screen. X 2900, the reference point, can be a point that is in the middle of E 2910 and H 2920

In another embodiment, the entity expands the area covered in FIG. 19B so that the buyer may know more about the areas around E 2910 and H 2920. The MPS entity may determine a margin parameter for determining the margins of what is displayed. The MPS entity can zoom in or out, i.e. magnify or shrink an image being displayed, and display a map according to the margin parameter. The margin parameter may be a percentage of the horizontal or vertical distance between references points E 2910 (the highway exit) and H 2920 (buyer's home). The following is an example of how a map is zoomed by using horizontal distance between two references points. In FIG. 19B and FIG. 19C, LMNO is the border of the area available for map displaying on the buyer's screen. In FIG. 19C, E′ 2940 is a hypothetical point that has the same longitude with H 2920 and has the same latitude with E 2910. EE′ is the horizontal distance between E 2910 and H 2920. Assume the distance of EE′ is ten miles. The parameter used is 20%. The entity can then zoom on the map to include the area EF in the map. The horizontal distance between E 2910 and F 2950 is 2 miles. (10 miles×20%=2 miles). The entity can use the same method to include area HG in the map. The horizontal distance between H 2920 and G 2960 is also 2 miles. A map shown to a buyer is in scale. After the zooming, FIG. 19 C can be the map displayed to a buyer. Pickup locations are displayed with the map. FIG. 19 C can be the only map displayed to a buyer.

As an alternative, the entity can use the distance between E′ 2940 and H 2920 with a margin parameter to zoom a map for the buyer's use.

The entity may allow a buyer to select a margin parameter. In this case, there can be a template displayed to the buyer so that the buyer can enter his/her preferred margin parameter and the entity can display a map to the buyer according to the margin parameter.

In commercial mapping, it is very common to zoom a map by zooming level. Using Yahoo Map as an example, it displays a map from Zoom Level 1 to Zoom Level 10. Zoom level 10 displays the whole country. Zoom level 1 displays the buyer's home and it's near by streets. The zooming is discrete. It “jumps” from one level to the next level and is not continuous. In this situation, the entity can zoom the map to the highest level that covers both reference points E 2910 and H 2920. A higher zoom level covers a larger area.

By using this method, a buyer only receives the map with the area and pickup locations he/she can use. Unnecessary information is discarded.

When a MPS entity selects a pickup location for a buyer, the MPS entity can calculate the distance of a pickup location to the buyer's travel route and selects the one with the shortest distance to the route for the buyer to use.

When a server generates a buyer's travel route, the server may choose to discard a portion of the route and not display it to the buyer. For example, the server may select a highway in a buyer's travel route and not display it to the buyer.

In one embodiment, A MPS uses the combination of the following methods to produce and deliver a meal to reach efficiency. 1). Meal orders are passed to a BFP before the day of delivery. In this way, a BFP can have enough time to procure materials needed. 2) A BFP uses its idled time, e.g. from 2:00 p.m. to 3:30 p.m. to produce orders. In this way, idled facilities can be fully used. And, 3). A MPS station goes to no more than 4 BFPs to pick up orders. In this way, a BFP can easily goes to a pickup location before the start of its station time. In addition, in this way, a BFP can be assigned to produce more items and save more operation costs.

Having thus described several exemplary implementations of the invention, it will be apparent that various alterations and modifications can be made without departing from the inventions or the concepts discussed herein. Such operations and modifications, though not expressly described above, are nonetheless intended and implied to be within the spirit and the scope of the inventions. Accordingly, the foregoing description is intended to be illustrative only and while the present invention has been described in regards to particular embodiments, it is recognized that additional variations of the present invention may be devised without departing from the inventive concept.

What I claim is:

1. A method of scheduling and delivering a product to a buyer, comprising:
receiving an order for a product from a buyer;
receiving a delivery area identifier from the buyer;
employing the delivery area identifier to select a pickup location for the buyer's order from among a plurality of predetermined pickup locations;
identifying the address of the selected pickup location;
loading the products into a mobile pickup station;
dispatching the mobile pickup station to the selected pickup location; and
stationing the mobile pickup station at the pickup location for a predetermined station time during which the buyer can pick up the order from the mobile pickup station;
wherein the station time starts at a predetermined starting time and ends at a predetermined ending time, the mobile pickup station being removable from the pickup location upon the end of the ending time, whereby the buyer can pick up the order from the mobile pickup station.

2. The method of claim 1, wherein the product is a food product.

3. The method of claim 1, further comprising the steps of:
(a) transmitting the address of the pickup location and the buyer's order to a producer for production of the product; and
(b) receiving the products from the producer.

4. The method of claim 1, further comprising the steps of:
(a) producing the product;
(b) packing the product to a stage suitable for shipping; and
(c) preparing a shipping label containing the address of the pickup location and other buyer information; and
(d) attaching the label to the product.

5. The method of claim 1, wherein a plurality of products having the same pickup location are loaded into the same mobile pickup station.

6. The method of claim 1, wherein the station time is determined by:
selecting a period of time;
determining a number of potential buyers passing by the pickup location during the selected period of time; and
determining whether the cost of stationing the mobile pickup station at the pickup location during the period of time exceeds the amount of profit that can be made by providing products to buyers during the period of time, wherein the period of time is excluded from the station time at the pickup location if the cost of stationing a mobile pickup station during the period of time exceeds the amount of profit that can be made by providing products to buyers during the period of time.

7. The method of claim 1 wherein the station time is determined by:
determining a number of potential buyers passing by the pickup location during the selected period of time; and
determining the carrying capacity of the mobile pickup station, wherein if the number of customers that are projected to arrive at the pickup location to pick up orders during the period of time is less than the carrying capacity of the mobile pickup station, then the selected period of time is included in the station time.

8. The method of claim 1 wherein the station time is determined by:
selecting a period of time;
determining a number of potential buyers passing by the pickup location during the selected period of time;
using the number of potential buyers to determine a projected number of orders for products that will be picked up during the period of time;
using the projected number of orders for products that will be picked up during the period of time to determine an amount of profit that can be made by providing the orders to buyers during the period of time;
determining a cost of stationing the mobile pickup station at the pickup location during the period of time; and
determining whether the cost of stationing the mobile pickup station at the pickup location during the period of time exceeds the amount of profit that can be made by providing the orders to buyers during the period of time, wherein the period of time is excluded from the station time at the pickup location if the cost of stationing a mobile pickup station during the period of time exceeds a predetermined amount of profit that can be made by providing the orders to buyers during the period of time.

9. The method of claim 1, further comprising:
receiving from the buyer a delivery date on which the buyer wants to obtain the product;
receiving from the buyer a specification of a preferred product;
using the delivery date and the specification to select the preferred product for the buyer for the date that the buyer wants to obtain the product; and
delivering the product to the buyer on the delivery date.

10. The method of claim 1, wherein the product is a perishable food product, and wherein the mobile pickup station is operated by a first entity and the perishable food product is produced by a second entity, further comprising the step of providing compensation to the first entity operating the mobile pickup station only from the second entity and not from the buyer.

11. The method of claim 10, wherein the first entity employs a delivery person and wherein the delivery person only receives compensation from the first entity and not from the buyer.

12. The method of claim 10, wherein a plurality of products are available to be ordered by the buyer, the plurality of products comprising a least-priced product, further comprising the step of delivering the least-priced product, the product comprising at least one ordering unit of a meal item.

13. The method of claim 1, wherein selecting the pickup location further comprises:
receiving the buyer's home address and office address;
using the buyer's home address and office address to project the buyer's preferred pickup location; and
delivering the buyer's order to the buyer's preferred pickup location.

14. The method of claim 1, wherein selecting the pickup location further comprises:
receiving the buyer's home address or office address;
determining highways around the buyer's home or office;
identifying the closest exit on the highways to the buyer's home or office;
determining an off-ramp street or road connects the exit;
selecting a pickup location along the off-ramp street or road;
delivering the buyer's order to the pickup location waiting for the buyer to pick up the order.

15. The method of claim 1, wherein selecting the pickup location further comprises:
receiving the buyer's home or office address;
determining highways around the buyer's home or office;
identifying exits on the highways;
determining the shortest route connects the exits with the buyer's home or office;
selecting a pickup location along the route; delivering the buyer's order to the pickup location waiting for the buyer to pick up the order.

16. The method of claim 1, where selecting the pickup location further comprises:
receiving the buyer's home address from the buyer;
identifying the closest highway to the buyer's home;
identifying the exit on the highway that is the closest to the buyer's home;
determining a margin parameter for a map displayed to the buyer;
zooming the map by using the margin parameter until the map displays only the exit, the buyer's home, and the area defined by the margin parameter; and
displaying available pickup locations to the buyer on the map.

17. A method for scheduling and delivery of a product along a commuting route, comprising:
determining a plurality of pickup locations;
determining a location parameter value for each pickup location;
receiving commuting information from a buyer, the commuting information including a beginning address and an ending address;
calculating using a computer the commuting route traveled by the buyer, the commuting route connecting the beginning address and the ending address;
determining the parameter value of each point on the commuting route;
comparing the parameter value of each pickup location with the parameter value of each point on the commuting route;
identifying a pickup location having the same parameter value with a point on the commuting route;
selecting the pickup location as the pickup location to be used by the buyer; and
delivering the product to the pickup location with a mobile pickup station.

18. The method of claim 17, further comprising:
stationing the mobile pickup station at the pickup location for a predetermined station time during which the buyer can pick up the order from the mobile pickup station, wherein the station time starts at a predetermined starting time and ends at a predetermined ending time, the mobile pickup station being removable from the pickup location upon the end of the ending time, whereby the buyer may pick up the order from the mobile pickup station.

19. The method of claim 17, further comprising:
(a) receiving an order for a product from the buyer;
(b) relating the buyer's order to the pickup location;
(c) identifying the address of the selected pickup location;
(d) transmitting the address of the pickup location and the buyer's order to a producer of the product;
(e) receiving the product from the producer;
